(19) United States
(12) Patent Application Publication
(10) Pub. No.: US 2013/0083148 A1
(43) Pub. Date: Apr. 4, 2013

(54) OPTICAL SCANNING DEVICE, AND IMAGE FORMING APPARATUS

(71) Applicants: Naoki MIYATAKE, Kanagawa (JP); Tadashi NAKAMURA, Tokyo (JP)

(72) Inventors: Naoki MIYATAKE, Kanagawa (JP); Tadashi NAKAMURA, Tokyo (JP)

(21) Appl. No.: 13/628,382

(22) Filed: Sep. 27, 2012

(30) Foreign Application Priority Data
Oct. 4, 2011 (JP) 2011-220557

(51) Int. Cl. B41J 2/435; G02B 26/08

(52) U.S. Cl. 347/224; 359/204.1

(57) ABSTRACT

An optical scanning device including multiple light sources to emit multiple light beams for scanning different scanning surfaces; a light deflector having multiple reflection/deflection surfaces rotating in the main scanning direction to reflect and deflect the light beams such that at least two light beams are deflected by same one of the reflection/deflection surfaces at different angles in a sub-scanning direction relative to the normal line of the reflection/deflection surface; and a scanning lens to focus the deflected light beams on the scanning surfaces. At least one surface of the scanning lens has multiple refracting surfaces arranged side by side in the sub-scanning direction, and each of the refracting surfaces has a positive refracting power in the sub-scanning direction, and vertices of the refracting surfaces are shifted in the sub-scanning direction from intersections of the light beams with the refracting surfaces toward the center of the scanning lens.

### CROSS-REFERENCE TO RELATED APPLICATIONS

This patent application is based on and claims priority pursuant to 35 U.S.C. §119 to Japanese Patent Application No. 2011-220557, filed on Oct. 4, 2011, in the Japan Patent Office, the entire disclosure of which is hereby incorporated herein by reference.

### FIELD OF THE INVENTION

The present invention relates to an optical scanning device. Particularly, the present invention relates to an optical scanning device using an oblique incidence type optical system. In addition, the present invention also relates to an image forming apparatus using the optical scanning device.

### BACKGROUND OF THE INVENTION

Initially, optical scanning devices and image forming apparatuses will be described.

Optical scanning devices used for laser printers typically have a configuration such that a light beam emitted by a light source is deflected by a light deflector, and then focused and scanned by a scanning and focusing optical system such as ID lenses such that the light beam forms a light spot on a scanning surface to be scanned, and the scanning surface is optically scanned in a main scanning direction by light spots. The scanning surface is typically a surface of a photosensitive layer of a photoreceptor including a photosensitive material, and more specifically a peripheral surface of a cylindrical photoreceptor drum.

In addition, there is a full color image forming apparatus having four photoreceptors, which are serially arranged in a recording material feeding direction; an irradiator to deflect light beams emitted by plural light sources while scanning the light beams using only one light deflector to irradiate the photoreceptors at the same time after passing the light beams through respective scanning and focusing optical systems, thereby forming electrostatic latent images on the photoreceptors; developing devices to develop the electrostatic latent images on the corresponding four photoreceptors with different color developers (such as yellow, magenta, cyan and black developers), thereby forming visible color images on the photoreceptors; transferring devices to transfer the visible color images on the corresponding four photoreceptors to a recording material; and a fixing device to fix the visible color images on the recording material, resulting in formation of a full color image.

Such image forming apparatuses, which form two or more color images or full color images using two or more sets of an optical scanning device and a photoreceptor, are known as tandem image forming apparatuses.

Next, the oblique incidence type optical system will be described.

In attempting to reduce the costs of an optical scanning device for use in color image forming apparatuses, a technique (an oblique incidence type optical system) is proposed in which light beams are incident on a reflection/deflection surface of a light deflector at an angle in a sub-scanning direction. In such an oblique incidence type optical system, multiple light beams, which are deflected by respective reflection/deflection surfaces, are guided to the respective scanning surfaces (i.e., the surfaces of the respective photoreceptors) after separated by light reflecting mirrors or the like. In this regard, the angle of a light beam in the sub-scanning direction (i.e., the incident angle of a light beam to the reflection/deflection surface) is set to such an angle that the multiple light beams can be separated from each other by light reflecting mirrors or the like.

By using such an oblique incidence type optical system, two adjacent light beams can be separated so as to have a desired interval by mirrors or the like without enlarging the light deflector (i.e., without using a multi-stage polygon mirror staged multiply in the sub-scanning direction, or a polygon mirror having a large thickness). Namely, a low-cost optical scanning device can be provided without increasing the size of a light deflector in the sub-scanning direction. For example, when such a thin polygon mirror is used as a light deflector, it is not necessary to apply large energy to the polygon mirror even when the polygon mirror is rotated at a high speed. In addition, increase of wind noise caused by the polygon mirror rotated at a high speed can be prevented.

However, oblique incidence type optical systems typically have a drawback such that since light beams are incident on end portions of a scanning lens while twisted, the wave aberration is increased, thereby deteriorating the optical property of the light beams and increasing the beam spot, and it becomes impossible to form high quality images. In this regard, since light beams incident on a central portion of the scanning lens are hardly twisted, deviation of the beam spot diameter increases in the main scanning direction. Thus, when the wave aberration is increased, the diameter of a beam spot of a light beam passing the end portions of a scanning lens increases. Therefore, solving this problem makes it possible to perform a high quality optical scanning operation, which is earnestly desired recently.

In addition, oblique incidence type optical systems typically have another drawback such that bending of a scanning line is large. In this regard, the amount of bending of a scanning line changes depending on the oblique incidence angle of the light beam in the sub-scanning direction. Therefore, when multiple color images are formed using multiple light beams, which have different oblique incidence angles, a misalignment problem is caused in which when visible color images, which are formed by developing electrostatic latent images formed on the respective photoreceptors by the light beams, are transferred so as to be overlaid, the color images are misaligned due to variation of the positions of the electrostatic latent images caused by bending of the scanning lines of the light beams.

In attempting to solve the problem, there is a proposal such that a first scanning lens, which has no curvature in the sub-scanning direction and which changes tilt eccentricity in the sub-scanning direction toward the main scanning direction, is provided at a location between a light deflector and a second scanning lens, which has a large refracting power in the sub-scanning direction, to correct the wave aberration. In addition, it is described therein that by using a similar surface for another scanning lens, which is arranged between the first scanning lens and the scanning surface to be scanned, bending of the scanning lines of the light beams can be corrected. The technique can prevent deterioration of the optical property specific to oblique incidence type optical systems, and can provide a low-cost and compact optical scanning device.

However, it is necessary for the oblique incidence type optical system to have a set of scanning lenses having at least two scanning lenses. Among these scanning lenses, the scanning lens provided on the side of the scanning surface is long, and is provided for each of the photoreceptors. Therefore, flexibility in designing layout for the light paths of from the light deflector to the scanning surfaces seriously deteriorates. Particularly, since optical scanning devices used for compact image forming apparatuses are required to have small size (particularly the length in the sub-scanning direction), it is hard to use such an optical scanning device having a set of scanning lenses for compact image forming apparatuses.

The proposal includes an example in which a scanning lens is eccentrically arranged to correct bending of scanning lines. However, in order to correct bending of scanning lines formed by light beams having different oblique incidence angles, such a scanning lens has to be provided for each scanning surface (for each light beam), thereby increasing the costs and size of the optical scanning device, and deteriorating flexibility in designing the optical scanning device.

Thus, the problems of conventional optical scanning devices (such as the proposed optical scanning device mentioned above) to be solved are as follows.

The first problem to be solved is to prevent deterioration in wave aberration, which is specific an the oblique incidence type optical system and which is caused when the oblique incidence type optical system uses at least one scanning lens for multiple light beams emitted by multiple light sources. Namely, the first problem to be solved is to form beam spots having diameters in a proper range.

The second problem to be solved is to correct bending of scanning lines specific to the oblique incidence type optical system, and to reduce the degree of misalignment of color images produced by color image forming apparatuses using the oblique incidence type optical scanning device.

The third problem to be solved is to use a common lens for the scanning lens to enhance the sub-scanning magnification of the scanning system while reducing variation in intervals between scanning lines in the sub-scanning direction.

For these reasons, the inventors recognized that there is a need for an optical scanning device which has a small size in the sub-scanning direction while having good flexibility in designing layout for the light paths and which has good optical property while having low costs by reducing the number of parts.

### BRIEF SUMMARY OF THE INVENTION

As an aspect of the present invention, an optical scanning device is provided which includes multiple light sources to emit multiple light beams for scanning multiple different scanning surfaces; a light deflector having multiple reflection and deflection surfaces and rotating on a rotation axis in a main scanning direction to reflect and deflect the multiple light beams such that at least two light beams of the multiple light beams are reflected and deflected by the same one of the multiple reflection and deflection surfaces at different angles in a sub-scanning direction relative to a normal line of the same one of the multiple reflection and deflection surfaces; and at least one scanning lens to focus the light beams reflected and deflected by the same one of the multiple reflection and deflection surfaces on at least two of the multiple different scanning surfaces, respectively.

At least one surface of the scanning lens has multiple refracting surfaces arranged side by side in the sub-scanning direction, and each of the multiple refracting surfaces has a positive refracting power in the sub-scanning direction, and vertices of the refracting surfaces are shifted in the sub-scanning direction from intersections of the light beams with the multiple refracting surfaces toward the center of the scanning lens.

As another aspect of the present invention, an image forming apparatus is provided which includes at least two image bearing members; and the above-mentioned optical scanning device to scan the surfaces of the image bearing members to form electrostatic latent images on the surfaces of the image bearing members.

The aforementioned and other aspects, features and advantages will become apparent upon consideration of the following description of the preferred embodiments taken in conjunction with the accompanying drawings.

### BRIEF DESCRIPTION OF THE SEVERAL VIEWS OF THE DRAWINGS

FIG. 1 is a schematic plan view illustrating the main portion of an example of the optical scanning device of the present invention;

FIG. 2 is a schematic side view illustrating the main portion of the optical scanning device illustrated in FIG. 1;

FIG. 3 is a schematic view for describing an optical scanning lens of the optical scanning device illustrated in FIG. 1;

FIG. 4 is a schematic view illustrating a light deflector for use in the optical scanning device of the present invention;

FIG. 5 is a schematic view for describing variation in reflection point of a light beam in the sub-scanning direction caused by variation of the positions of reflecting surfaces of the light deflector illustrated in FIG. 4;

FIG. 6 is a schematic view for describing the interval between light beams in the sub-scanning direction when the oblique incidence angle of the light beams is relatively small;

FIG. 7 is a schematic view for describing another example of the optical scanning device in which reflection points of light beams on a reflecting surface are separated from each other in the sub-scanning direction;

FIG. 8 is a schematic side view illustrating an example of the image forming apparatus of the present invention;

FIG. 9 is a schematic side view illustrating optical elements for use in the optical scanning device of the present invention;

FIG. 10 is a graph showing deviation in beam spot diameter in the main scanning direction when changing the image height in Example 1 of the optical scanning device of the present invention;

FIG. 11 is a graph showing deviation in beam spot diameter in the sub-scanning direction when changing the image height in Example 1 of the optical scanning device;

FIG. 12 is a graph showing bending of a scanning line in Example 1 of the optical scanning device;

FIG. 13 is a schematic plan view illustrating the main portion of another example of the optical scanning device of the present invention;

FIG. 14 is a schematic side view illustrating the main portion of the optical scanning device illustrated in FIG. 13;

FIG. 15 is a schematic view for describing optical scanning lenses of the optical scanning device illustrated in FIG. 13;

FIG. 16 is a schematic view illustrating a light deflector for use in the optical scanning device illustrated in FIG. 13;

FIG. 17 is a schematic view for describing variation in reflection point of a light beam in the sub-scanning direction caused by variation of the positions of reflecting surfaces of the light deflector illustrated in FIG. 16;

FIG. 18 is a schematic view for describing the interval between light beams in the sub-scanning direction when the oblique incidence angle of the light beams is relatively small in the optical scanning device illustrated in FIG. 13;

FIG. 19 is a schematic view for describing another example of the optical scanning device in which reflection points of light beams on a reflecting surface are separated from each other in the sub-scanning direction;

FIG. 20 is a schematic side view illustrating another example of the image forming apparatus of the present invention;

FIG. 21 is a graph showing deviation in beam spot diameter in the main scanning direction when changing the image height in Example 2 of the optical scanning device of the present invention;

FIG. 22 is a graph showing deviation in beam spot diameter in the sub-scanning direction when changing the image height in Example 2 of the optical scanning device; and

FIG. 23 is a graph showing bending of a scanning line in Example 2 of the optical scanning device.

### DETAILED DESCRIPTION OF THE INVENTION

The optical scanning device of the present invention and the image forming apparatus using the optical scanning device will be described by reference to drawings.

Initially, a first example of the present invention will be described.

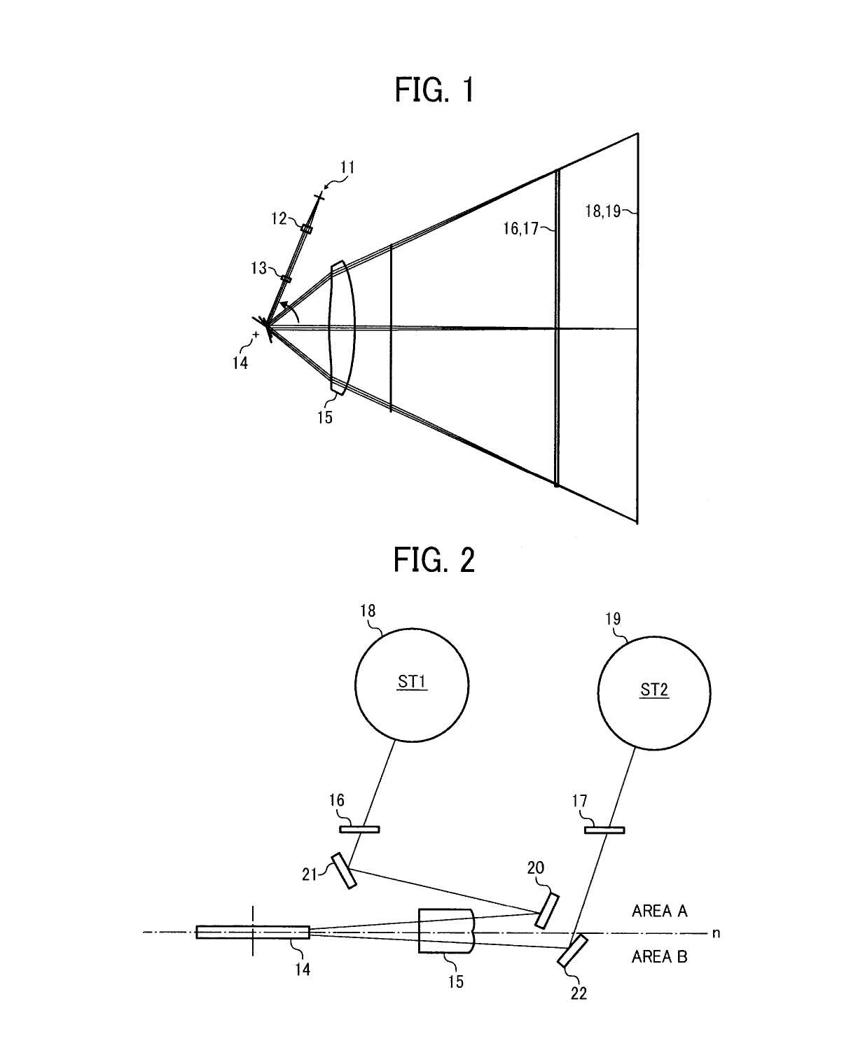

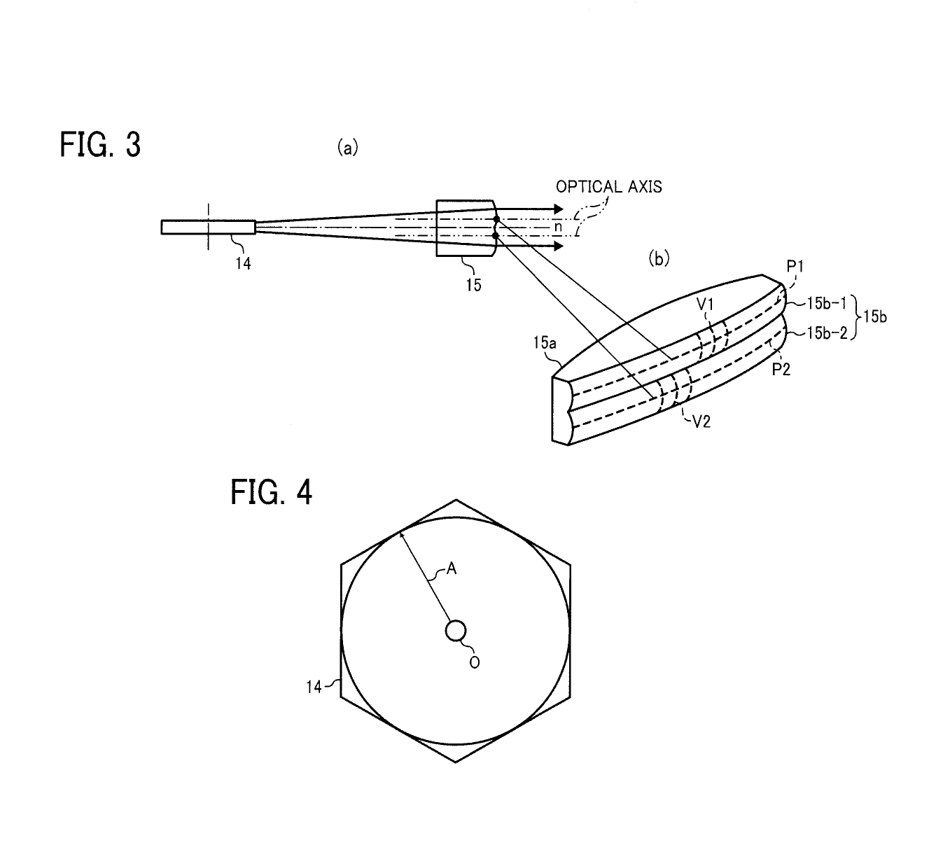

FIGS. 1-3 illustrate a main portion of an example of the optical scanning device of the present invention. Specifically, FIG. 1 is a schematic plan view illustrating the main portion of the optical scanning device; FIG. 2 is a schematic side view illustrating the main portion of the optical scanning device; and FIG. 3 illustrates an optical scanning lens of the optical scanning device, wherein (a) is a schematic side view of the scanning lens and (b) is a schematic perspective view of the scanning lens.

The optical scanning device illustrated in FIGS. 1-3 includes a light source 11, a coupling lens 12, a cylindrical lens 13, a light deflector 14, a scanning lens 15, optical elements 16 and 17, and light reflecting mirrors 20, 21 and 22. Numerals 18 and 19 denote surfaces (i.e., scanning surfaces) of photoreceptors ST1 and ST2.

The oblique incidence type optical scanning device will be described by reference to FIGS. 1 and 2.

Specific examples of the light source 11 include laser diodes. A divergent light flux emitted by the light source 11 is converted by the coupling lens 12 to a light flux suitable for the following optical system. The thus converted light flux is a parallel light flux, a slightly divergent light flux, or a slightly convergent light flux.

The light flux passing through the coupling lens 12 is condensed in the sub-scanning direction by the cylindrical lens 13, and is incident on a rotating reflection/deflection surface of the light deflector 14. Specific examples of the light deflector 14 include polygon mirrors having multiple peripheral surfaces serving as reflection/deflection surfaces. In this regard, the light flux passing through the cylindrical lens 13 is incident on the reflection/deflection surface at an oblique angle in the sub-scanning direction relative to a normal line (n) as illustrated in FIG. 2. Such an obliquely incident light flux can be formed by slanting the light source 11, the coupling lens 12 and the cylindrical lens 13 at a predetermined angle, or by using a light reflecting mirror to change the angle of the light flux. Alternatively, it is possible to shift the optical axis of the cylindrical lens 13 in the sub-scanning direction so that the light beam passing through the cylindrical lens 13 proceeds to the reflection/deflection surfaces of the light deflector 14 at an angle.

The light fluxes incident on the reflection/deflection surface of the light deflector 14 are subjected to deflection scanning with constant acceleration by the polygon mirror, which is rotated with constant acceleration, to scan the scanning surfaces 18 and 19 of the photoreceptors ST1 and ST2 after passing through the scanning lens 15. The light fluxes deflected from the reflection/deflection surface are focused on the scanning surfaces, thereby forming light spots on the scanning surfaces while scanning the light spots.

Next, the feature of the optical system of the optical scanning device of the present invention will be described by reference to a case where the optical scanning device is used for tandem color image forming apparatuses.

FIG. 2 illustrates an example of the optical scanning device of the present invention to scan two scanning surfaces. Light beams emitted by the light source 11 (not shown in FIG. 2) are obliquely incident on the same one of the reflection/deflection surfaces of the light deflector 14. Specifically, light beams are obliquely incident on the reflection/deflection surface from both sides of the normal line (n) of the reflection/deflection surface relative to the sub-scanning direction (i.e., from areas A and B), and then reflected toward the opposite sides (i.e., toward areas B and A). After passing through the common scanning lens 15, the light beams are separated from each other by a combination of light reflecting mirrors 20 and 21, and a light reflecting mirror 22 so as to be guided to the scanning surfaces 18 and 19 of the photoreceptors after passing through the optical elements 16 and 17.

In this example, the number of reflecting minors to reflect a light beam, which is incident on the reflection/deflection surface from the area A and reflected toward the area B, is odd (in the example illustrated in FIG. 2, the number of reflecting mirrors is one (i.e., the light reflecting mirror 22)). In contrast, the number of reflecting mirrors to reflect a light beam, which is incident on the reflection/deflection surface from the area B and reflected toward the area A, is even (in the example illustrated in FIG. 2, the number of reflecting mirrors is two (i.e., the light reflecting minors 20 and 21)). In this regard, the light beams illustrated in FIG. 2 are light beams reflected from and deflected by the light deflector 14, and the incident light beams thereof (which are not illustrated in FIG. 2) are incident on the deflector from the opposite areas in the sub-scanning direction. Thus, by arranging light reflecting mirrors 20-22, the directions of bending of the scanning lines formed by the light beams, which bending is caused by an oblique incidence type optical system, can be identical to each other, thereby reducing the degree of the misalignment of color images.

By using such a light deflector (light deflector 14) in which light beams from plural light sources are obliquely incident on reflection/deflection surfaces thereof relative to the normal line (n) of the reflection/deflection surfaces, the length of the light deflector in the sub-scanning direction can be decreased, thereby making it possible that the costs of the light deflector, which has a relatively high cost compared to other parts constituting the optical scanning device, can be reduced so as to be lower than that of a light deflector used for an optical scanning device, in which light beams are incident in a direction parallel to the normal line (n) of the light deflector. In addition, since the light deflector 14 can be miniaturized, power consumption and noise of the light deflector can be reduced, thereby making it possible to provide an environmentally friendly optical scanning device with low costs. Hereinafter, the angle of light beams relative to the normal line (n) is sometimes referred to as an oblique incidence angle.

Further, in order to reduce the number of parts and the costs of the optical scanning device, the scanning lens 15 is commonly used for all the light beams reflected from the same reflection/deflection surface. Conventional optical scanning devices typically have a configuration such that plural scanning lenses are overlaid in the sub-scanning direction. In contrast, the scanning lens 15 can have a configuration such that plural lens surfaces are arranged so as to be close to each other in the sub-scanning direction, thereby making it possible to reduce the oblique incidence angle, and to decrease the size of the scanning lens. Particularly, by reducing the oblique incidence angle, a large effect can be produced as mentioned later. In addition, unlike conventional optical scanning devices in which scanning lenses are used for respective scanning surfaces, the optical scanning device of this example has good flexibility in designing the layout thereof, thereby making it possible to miniaturize the optical scanning device.

Oblique incidence type scanning systems tend to cause a problem in that the wave aberration often deteriorates. Unless the light entering surface of the scanning lens thereof has a shape of arc in the main scanning direction, whose center is the light reflection point on the reflection/deflection surface of the light deflector thereof, the distance between the reflection/deflection surface of the light deflector and the light entering surface of the scanning lens changes depending on the image height (i.e., the distance changes in the main scanning direction). In general, it is difficult to prepare a scanning lens having such a light entering surface because the optical property of the lens deteriorates.

Namely, it is difficult for a light beam deflected by a light deflector to vertically enter the light entering surface of a scanning lens at any image height in the main scanning direction, and the light beam enters the light entering surface at an angle. A light flux of light beams reflected and deflected by a light deflector has a certain width in the main scanning direction, and therefore light beams on both ends (in the main scanning direction) of the light flux have different traveling lengths when traveling from the reflection/deflection surface of the light deflector to the light entering surface of a scanning lens. In addition, since the light beams obliquely enter the reflection/deflection surface, the light beams have an angle in the sub-scanning direction, and therefore the light beams enter the scanning lens while twisted. When the light flux thus twisted enters the scanning lens, which has a strong refracting power in the sub-scanning direction, the wave aberration increases. Namely, the light flux enters the scanning lens having a strong refracting power in the sub-scanning direction while skewing, and the light beams of the light flux on both the sides thereof in the main scanning direction perform different refraction. Therefore, the light beams are not focused on one point of the scanning surface. Namely, since the wave aberration deteriorates, the beam spot diameter widens.

As illustrated in FIG. 1, the incidence angle in the main scanning direction of light entering the scanning lens 15 increases as the light entering point is apart from the center of the scanning lens in the main scanning direction. Therefore, the light entering points of light beams on both the ends of a light flux are largely different from each other in the sub-scanning direction, i.e., the light flux is largely twisted, and the beam spot seriously increases as the light entering point approaches the end portions of the scanning lens in the main scanning direction.

In addition, oblique incidence type scanning systems have a disadvantage over conventional lateral incidence type scanning systems that bending of a scanning line is larger. The amount of bending of a scanning line formed by a light beam depends on the incidence angle (in the sub-scanning direction) of the light beam. Therefore, when electrostatic latent images formed by different light beams to form different visible color images are developed with different color developers, the misalignment problem in that the positions of the visible color images are different from each other is caused.

For example, when the light entering surface of a scanning lens, which has strong refracting power in the sub-scanning direction, has a shape of arc in the main scanning direction, whose center is the light reflection point on the reflection/deflection surface of a light deflector, the distance between the reflection/deflection surface of the light deflector and the light entering surface of the scanning lens is constant independently of the light entering position on the scanning lens in the main scanning direction (i.e., image height), and therefore the distance does not change when performing scanning. However, in general, it is difficult for the scanning lens to have such a shape because the optical property of the lens deteriorates. Namely, it is difficult for light beams deflected by a light deflector to vertically enter the light entering surface of a scanning lens at any position (image height) in the main scanning direction, and light beams enter the light entering surface at an angle as illustrated in FIG. 1.

Thus, since light beams have an angle in the sub-scanning direction because of being subjected to oblique incidence, the light paths of the light beams between the reflection/deflection surface of the light deflector 14 and the light entering surface of the scanning lens 15 change depending on the image height (i.e., the light entering position on the scanning lens in the main scanning direction). Specifically, as the light entering position is apart from the center of the scanning lens 15 in the main scanning direction, the light entrance position in the sub-scanning direction becomes higher or lower in the sub-scanning direction than that at the center of the scanning lens 15. In this regard, whether the light entrance position in the sub-scanning direction becomes higher or lower depends on the direction of the incidence angle of the light beam.

Accordingly, when light beams pass through the surface having a refracting power in the sub-scanning direction, the refracting powers that the light beams receive are different, thereby causing bending of the scanning line. In horizontal incidence type scanning systems, light beams proceed horizontally to a scanning lens, and therefore the light entering positions in the sub-scanning direction do not change and bending of a scanning line is not caused even when the distance between the reflection/deflection surface of a light deflector and the light entering surface of a scanning lens changes.

In the example of the optical scanning device illustrated in FIG. 3, the scanning lens 15, which is used for all the light beams reflected and deflected by the same reflection/deflection surface of the light deflector 14, has a structure such that one surface thereof (in this example a surface 15b closer to the scanning surfaces 18 and 19) has plural surfaces 15b-1 and 15b-2 each having a positive refracting power, and generatrices P1 and P2, which are defined as a cluster of vertices of profile lines V1 and V2 on the lens surfaces extending in the sub-scanning direction, are present in planes parallel to the normal line (n) of the reflection/deflection surface of the light deflector 14. In this regard, a surface 15a of the scanning lens 15 opposite to the surface 15b is flat in the sub-scanning direction, and is parallel to the rotation center of the polygon mirror (light deflector). Namely, the scanning lens 15 is arranged so as to be parallel to the reflection/deflection surface of the light deflector 14.

In general, in optical scanning devices, the reflection/deflection surface of a light deflector and a scanning surface have conjugated relation with each other. Therefore, when the scanning lens 15 is arranged as described above, the deviation of magnification in the sub-scanning direction can be decreased at any positions of the scanning lens in the main scanning direction, i.e., the magnification in the sub-scanning direction can be substantially constant, thereby making it possible to correct bending of a scanning line. This is because the distances between the optical axes of the scanning lens 15 and the light reflection point on the reflection/deflection surface of the light deflector 14 are constant (i.e., the height of object is constant), and therefore the image can be formed at points having the same distances from the optical axes of the scanning lens 15 in the main scanning direction. In this example, since the light entering surface of the scanning lens 15 is flat, the normal line at the origin of the formula showing the profile of the light exiting surface of the scanning lens 15 is defined as an optical axis as illustrated in FIG. 3. The optical axes are parallel to the normal line (n) of the reflection/deflection surface of the light deflector 14, and the number of the optical axes is equal to the number of the light exiting surfaces (15b-1 and 15b-2) of the scanning lens 15.

In order to reduce deviation of magnification in the sub-scanning direction, it is effective to use a surface, in which the curvature thereof in the sub-scanning direction is changed in the main scanning direction, as well as making field curvature correction. However, when a light beam passes a position (i.e., off-axis position) far apart from an optical axis of the scanning lens in the sub-scanning direction, the influence of aberration is enhanced, thereby making it impossible that the image height is constant in the main scanning direction. Therefore, it is preferable that light beams pass near the optical axes.

In addition, in optical scanning devices for use in color image forming apparatuses, it is possible to reduce the degree of misalignment of color images, which is caused by bending of scanning lines, by setting a moderate number of light reflecting mirrors to control the direction of bending so as to be the same as mentioned above. Needless to say, when bending of scanning lines is large, the quality of images deteriorates. However, by using the optical scanning device of the present invention, high quality images can be produced.

In addition, correction of wave aberration is a problem to be solved in oblique incidence type scanning systems as well as correction of scanning line bending. In this example, the vertices of profile lines of the surfaces 15b-1 and 15b-2 are shifted in the sub-scanning direction from the intersections of the light beams with the surfaces to the center of the scanning lens, thereby correcting wave aberration.

Thus, in this example, the surfaces 15b-1 and 15b-2 of the scanning lens 15 are subjected to shift decentering so that a chief ray of light beams proceeding toward an end portion (in the main scanning direction) of an oblique incidence type scanning system, which portion has greatly deteriorated wave aberration, proceeds in substantially parallel with the normal line of the reflection/deflection surface of the light deflector 14 after exiting the scanning lens 15, and thereby coma aberration is corrected, resulting in satisfactory correction of wave aberration. In this regard, the chief ray of a light beam (light flux) means a ray passing through the center of a light path which is formed by an aperture or the like. In addition, the shift decentering means that the surfaces 15b-1 and 15b-2 are decentered toward the center of the scanning lens 15 in the sub-scanning direction so that a chief ray of light beams proceeding toward an end portion in the main scanning direction proceeds in substantially parallel with the normal line of the reflection/deflection surface of the light deflector 14 after exiting the scanning lens 15.

In this case, a light beam proceeding in the vicinity of the optical axis of the scanning lens 15 in the main scanning direction has an angle in the sub-scanning direction after exiting the light exiting surface of the scanning lens. However, since wave aberration caused by skew of a light flux is little, a problem concerning optical property does not occur. In addition, the amount of shift decreases as the oblique incidence angle decreases. Therefore, even when the surface of the scanning lens 15 is subjected to shift decentering, influence on correction of bending of a scanning line mentioned above is little when the oblique incidence angle is not greater than 5°. Therefore, it is possible to solve the problems specific to the oblique incidence type scanning system, i.e., deterioration of wave aberration and bending of a scanning line, at the same time. In this regard, detailed description will be made later by reference to several specific examples, and results such that when wave aberration is corrected, a beam spot having a desirable diameter can be obtained, and in addition bending of a scanning line can be controlled so as to be small (about 5 μm) are obtained in the examples.

In this example, the scanning lens 15 has plural lens surfaces (such as the surfaces 15b-1 and 15b-2 illustrated in FIG. 3), which are arranged side by side in the sub-scanning direction. In order that the scanning lens 15 has a function to focus light beams on a scanning surface, it is possible to use a scanning lens having only one lens surface, which is commonly used for plural light beams. However, as mentioned above, in order to correct wave aberration by subjecting the lens surface to shift decentering in the sub-scanning direction depending on the oblique incidence angles of light beams entering the scanning lens, it is necessary to change the positions of profile lines of the lens surface for each light beam in the sub-scanning direction. Therefore, it is necessary for the scanning lens to have plural lens surfaces to be used for plural light beams. When the scanning lens 15 has plural lens surfaces, it becomes possible that light beams pass in the vicinity of the vertices of the profile lines of the lens surfaces having a positive refracting power, namely, light beams do not pass points far apart from the vertices of the profile lines of the lens surfaces, thereby making it possible to correct bending of a scanning line while reducing influence of aberration.

Next, another example of the optical scanning device of the present invention will be described. The configuration of this second example is substantially the same as that of the first example of the optical scanning device mentioned above.

The optical scanning device of the present invention has good flexibility in designing the layout of the portion of from a light deflector to a scanning surface, and has a configuration such that a common scanning lens is set in the vicinity of a light deflector in order to reduce the size (particularly in the sub-scanning direction) of the optical scanning device.

In oblique incidence type scanning systems, a problem which occurs is that variation in the interval between scanning lines in the sub-scanning direction, which is caused by variation of reflection/deflection surfaces of the light deflector 14 (polygon mirror), increases.

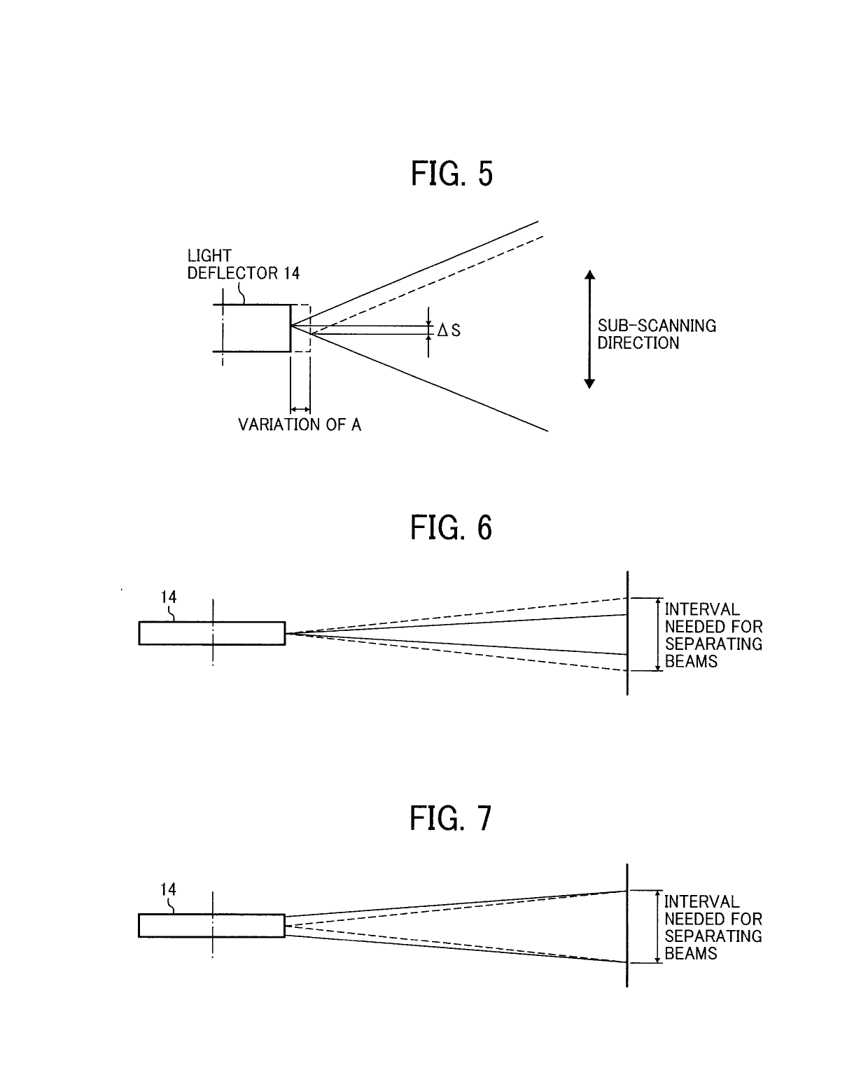

In the polygon mirror of the light deflector 14 illustrated in FIG. 4, the length of a perpendicular connecting a rotation center O of the polygon mirror and one of plural mirror surfaces (i.e., reflection/deflection surfaces) is defined as A. When the length A varies for the plural mirror surfaces, the reflection point varies in the sub-scanning direction as illustrated by a solid line and a broken line in FIG. 5, and therefore the focusing point on a scanning surface also varies in the sub-scanning direction. In general optical scanning systems which are not an oblique incidence type scanning system, the reflection point does not vary even when the length A varies, and therefore the focusing point on the scanning surface does not vary in the sub-scanning direction.

In addition, in the optical scanning device of the present invention, the flexibility in designing the layout of the device is enhanced while the size and costs of the device are reduced, and therefore the magnification is high as mentioned above. Accordingly, when the reflection point varies in the sub-scanning direction, the variation is enlarged on a scanning surface. Namely, the problem in that the reflection point varies in the sub-scanning direction is specific to the oblique incidence type scanning system, particularly, the oblique incidence type scanning system in which the magnification of the scanning optics in the sub-scanning direction is high. When the light deflector uses a polygon mirror having six reflection/deflection surfaces and the length A for the reflection/deflection surfaces varies, the positions of scanning lines varies in the sub-scanning direction at a cycle of six lines, thereby seriously deteriorating the image quality.

In particular, in a case where a scanning lens is set in the vicinity of a light deflector in order to reduce the number of scanning lenses used and the size of the optical scanning device, magnification (in the sub-scanning direction) of a scanning optics set between the reflection/deflection surface of the light deflector and a scanning surface, which have conjugated relation, is high. When magnification is high in an oblique incidence type scanning system, not only a problem in that variation in position of a focused image on a scanning surface, which is caused by variation in shape of optical elements used for a normal optical system of the optical scanning device, and assembling errors of the optical elements, increases, but also the above-mentioned problem in that the positions of scanning lines largely vary in the sub-scanning direction at a cycle of six lines occurs.

Therefore, in the optical system of the optical scanning device of the present invention, the scanning lens has a positive refracting power in the sub-scanning direction, and the surfaces of the scanning lens closer to scanning surfaces are decentered in the sub-scanning direction. As a result, it becomes possible to reduce magnification of the scanning optics in the sub-scanning direction and to reduce variation in position of scanning lines in the sub-scanning direction caused by variation in the length A of the reflection/deflection surfaces of the polygon mirror.

In order to further reduce the magnification, a method in which the scanning lens is set apart from the light deflector can be used. However, when the length of the light path from the light deflector to the scanning surface is constant, the field angle increases, and it becomes impossible to maintain good optical property. In a case where the field angle is not increased, the length of the light path has to be increased, resulting in increase in size of the optical scanning device.

In order to reduce magnification of the scanning optics in the sub-scanning direction to the utmost limit while preventing occurrence of such problems, it is preferable that lens surfaces having a positive refracting power are set at a location closer to scanning surfaces.

Next, another example of the optical scanning device of the present invention will be described. The configuration of this third example is substantially the same as those of the first and second examples of the optical scanning device mentioned above.

Another method for reducing variation in intervals between scanning lines in the sub-scanning direction, which is caused by variation in the length A of the polygon mirror of the light deflector 14, is to decrease the oblique incidence angle. By decreasing the oblique incidence angle, variation (ΔS in FIG. 5) in position of the light reflection point on the reflection/deflection surfaces of the polygon mirror, which is caused by variation in the length A of the polygon mirror, can be decreased, thereby making it possible to reduce the variation in intervals between scanning lines in the sub-scanning direction.

However, when the oblique incidence angle is low, it becomes hard to separate light beams to an extent such that the separated light beams can irradiate the scanning surfaces 18 and 19 of the photoreceptors ST1 and ST2 after passing through the scanning lens 15 as illustrated in FIG. 6. Specifically, in order to separate the light beams to an extent such that it is possible to set light reflecting mirrors for guiding the light beams to the scanning surfaces 18 and 19, it is preferable that the oblique incidence angle is as high as possible because the light reflecting mirrors can be set at locations closer to the light deflector 14. In this case, the size of the optical scanning device can be decreased. When the oblique incidence angle is low, a proper interval cannot be formed between the light beams, thereby causing a problem in that the light reflecting mirrors 20 and 22 cannot be set in the vicinity of the light reflector 14.

The scanning lens 15 of the optical scanning device of the present invention has plural convex surfaces (15b-1 and 15b-2 in FIG. 3), which have a positive refracting power and which are arranged side by side in the sub-scanning direction while located on the scanning surface side relative to the light traveling direction. The opposite surface 15a of the scanning lens 15 is flat in the sub-scanning direction. Since the convex surfaces 15b-1 and 15b-2, which may have the same form, are independent from each other, it is necessary for the main rays of the light beams passing the convex surfaces to have a predetermined interval in the sub-scanning direction. In this regard, since the light beams have respective oblique incidence angles to be separated from each other, the interval between the light beams in the sub-scanning direction increases as the light beams approach the scanning surfaces. Namely, since the scanning lens 15 has a configuration such that the lens surface 15b closer to the scanning surfaces 18 and 19 have convex surfaces (15b-1 and 15b-2) arranged side by side in the sub-scanning direction, and the other surface closer to the light deflector 14 is flat in the sub-scanning direction so as to be used for all light beams, it becomes possible to decrease the oblique incidence angles of light beams. Since the surface which is flat in the sub-scanning direction is a common surface for all of plural light beams, it is not necessary to separate the chief rays of the light beams at certain intervals in the sub-scanning direction.

In this regard, it is preferable that the common surface of the scanning lens 15, which is flat in the sub-scanning direction, is parallel to the rotation axis of the polygon mirror of the light reflector 14, and is perpendicular to the normal line (n) of the reflection/deflection surfaces of the light deflector 14. If the common surface of the scanning lens 15 has tilt eccentricity in the sub-scanning direction, it is difficult to control the sub-scanning direction magnification so as to be the same in the main scanning direction, resulting in enhancement of bending of a scanning line.

Next, another example of the optical scanning device of the present invention will be described. The configuration of this fourth example is substantially the same as those of the first, second and third examples of the optical scanning device mentioned above.

In order to decrease the oblique incidence angle, it is preferable that light beams cross at a point, which is located between the light source 11 and the light deflector 14 and is closer to the light deflector, so that the reflection points of the light beams on a reflection/deflection surface are separated in the sub-scanning direction.

Since the scanning lens 15 has a common lens which is prepared by integral molding and in which lens surfaces are arranged side by side in the sub-scanning direction, the interval between light beams passing through the scanning lens 15 can be narrowed. In this regard, since the transmission points of light beams in the scanning lens 15 vary in the sub-scanning direction due to production errors and assembly errors of the optical members used, it is necessary for each of the lens surfaces to have a certain transmission area, and therefore the interval between light beams passing through the scanning lens 15 has a lower limit. Therefore, when the scanning lens 15 is set so as to be close to the light deflector 14 to reduce the size of the optical scanning device, or when the flexibility in designing the layout of the optical scanning device is enhanced to reduce the size of the optical scanning device, the oblique incidence angle has to be increased.

Needless to say, the oblique incidence angle decreasing effects can be produced by the scanning lens 15 more effectively than in a case where conventional scanning lenses are set so as to be overlaid in the sub-scanning direction. However, when the scanning lens 15 is arranged so as to be closer to the light deflector 14 to enhance the optical property mentioned above, it is desired to further decrease the oblique incidence angle.

As illustrated in FIG. 7, light beams are not crossed in the sub-scanning direction on the reflection surface of the polygon mirror of the light deflector 14. In this example, light beams cross at a point which is located between the light source and the reflection/deflection surface of the light deflector, so that the reflection points of the light beams on the reflection/deflection surface of the light deflector are separated from each other. As a result, it becomes possible that the oblique incidence angle is decreased (i.e., change of the oblique incidence angle from the angle illustrated by broken lines to the angle illustrated by solid lines in FIG. 7) while maintaining the light beam interval needed for separating light beams in the sub-scanning direction. In this regard, it is not preferable from the viewpoint of costs, noises and power consumption of the light deflector 14 to increase the thickness (in the sub-scanning direction) of the reflection/deflection surfaces of the polygon mirror of the light deflector 14, and therefore the thickness is preferably from 3 mm to 4 mm. In contrast, in a case where light beams are parallel to the normal line (n) of the reflection/deflection surface of the light deflector, and the scanning lens has a structure such that lenses are overlaid in the sub-scanning direction, the thickness of the polygon mirror in the sub-scanning direction is generally from 8 mm to 10 mm. Therefore, even though the thickness of the polygon mirror in the sub-scanning direction is slightly increased in this example, increase in costs of the optical scanning device is little, and the effects to reduce noise and power consumption of the light deflector 14 can be satisfactorily produced.

In conventional oblique incidence type optical scanning devices, the oblique incidence angle is generally from 3° to 5° in order that the optical scanning devices have a proper optical layout. In this example, the oblique incidence angle is about 1°, and therefore the optical scanning device can have good optical property. This point will be described later in detail by reference to an example (Example 1).

In order to control the variation of intervals of scanning lines in the sub-scanning direction caused by variation of the length A of the polygon mirror of the light deflector 14, it is preferable to determine the angle in the sub-scanning direction of light beams incident to the light reflector 14 relative to the normal line (n) of the reflection/deflection surfaces so that the following relation is satisfied:

ΔS×β<5 μm,

wherein ΔS represents variation in position of reflection points on the plural reflection/deflection surfaces of the light deflector 14, and β represents magnification of the scanning lens 15. When the variation is greater than that, the image quality deteriorates (for example, images with uneven image density are formed).

By properly decreasing the magnification of the scanning optics in the sub-scanning direction (as mentioned before) while properly decreasing the oblique incidence angle (as mentioned above), increase in thickness in the sub-scanning direction of the light deflector 14 can be prevented, and the scanning lens 15 can be set so as to be close to the light deflector 14, resulting in maintenance of flexibility in designing layout of the optical scanning device. Therefore, a compact optical scanning device, which has good optical property and in which variation of intervals of scanning lines in the sub-scanning direction is reduced, can be provided.

Plural light beams emitted by the light source 11 are focused in the vicinity of the reflection/deflection surfaces of the light deflector 14 by an optical element such as the cylindrical lens 13. In this regard, it is preferable that the optical element is commonly used by the plural light beams traveling toward the same reflection/deflection surface, and is set at a cross point at which the light beams cross in the sub-scanning direction. In this regard, the optical element (such as the cylindrical lens 13) having a function to focus light beams in the sub-scanning direction in the vicinity of the reflection/deflection surface has a problem to be solved concerning the installation location thereof. Specifically, when a cylindrical lens is provided for each light source, it is necessary to increase the oblique incidence angle of light beams.

Therefore, in this example, the optical element (such as the cylindrical lens 13) is commonly used by plural light beams traveling toward the same reflection/deflection surface, and is set at a cross point at which the plural light beams cross in the sub-scanning direction. As a result, it becomes possible to focus the light beams in the vicinity of the reflection/deflection surface without largely change the oblique incidence angle of the light beams.

In this regard, it is also possible that two light sources 11 are set so as to be separated in the main scanning direction, and an optical element (such as the cylindrical lens 13) is provided for each light source. In this case, by changing the form of each of the surfaces 15b of the scanning lens 15, the optical scanning device can have good optical property.

However, in order that the optical scanning device has merits such that the number of parts is reduced, and the lens surface is commonly used, the above-mentioned example is preferable.

In addition, in order to avoid interference of the coupling lens 12 to change diverging light emitted by the light source 11 to a desired light flux state (i.e., to perform coupling), it is possible to separate the light sources 11 in the main scanning direction, and the optical element (such as the cylindrical lens 13) is commonly used by the light beams emitted by the light sources. In this regard, it is preferable that the light beams are crossed in the vicinity of the reflection/deflection surface of the light deflector 14 in the main scanning direction. If the distance between the light sources is relatively short, the surfaces 15b of the scanning lens 15 may have the same shape.

Next, another example of the optical scanning device of the present invention will be described. The configuration of this fifth example is substantially the same as those of the first to fourth examples of the optical scanning device mentioned above.

The first to fourth examples of the optical scanning device mentioned above irradiate two scanning surfaces using the light deflector 14. By setting two sets of the optical scanning device (such as the first to fourth examples), it becomes possible to irradiate four scanning surfaces and to form a full color image. Alternatively, a method in which the light deflector 14, which has relatively high costs, is commonly used, and two sets of the above-mentioned optical scanning device are set so that the light beams emitted by the two optical scanning devices are reflected and deflected by the opposed reflection/deflection surfaces of the light deflector can also be used. In this case, by allowing the oblique incidence angles of all the light beams to be the same, the same two scanning lens can be used for the two optical scanning devices. Since conventional optical scanning devices used for forming full color images use four to eight scanning lenses, the number of scanning lenses can be reduced to one quarter to one half. In addition, the resultant optical scanning device has good optical property while having small size and low costs.

Next, the image forming apparatus of the present invention will be described. The image forming apparatus of the present invention uses one of the optical scanning devices mentioned above.

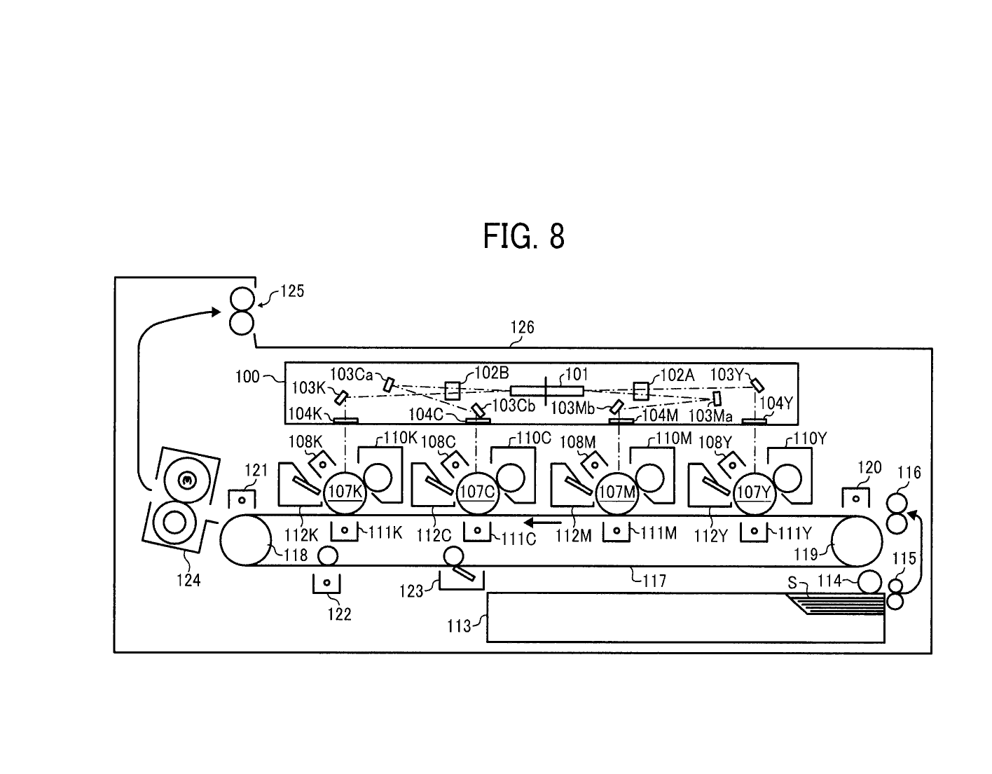

An example of the image forming apparatus of the present invention will be described by reference to FIG. 8. FIG. 8 is a schematic cross-sectional view illustrating the main portion of a tandem full color laser printer.

Referring to FIG. 8, the laser printer includes an optical scanning device 100, which is the optical scanning device of the present invention; photoreceptors 107 (photoreceptor 107Y for forming yellow images, photoreceptor 107M for forming magenta images, photoreceptor 107C for forming cyan images, and photoreceptor 107K for forming black images); chargers 108 (charger 108Y for forming yellow images, charger 108M for forming magenta images, charger 108C for forming cyan images, and charger 108K for forming black images); developing devices 110 (developing device 110Y for forming yellow images, developing device 110M for forming magenta images, developing device 110C for forming cyan images, and developing device 110K for forming black images); transfer chargers 111 (transfer charger 111Y for transferring yellow images, transfer charger 111M for transferring magenta images, transfer charger 111C for transferring cyan images, and transfer charger 111K for transferring black images); cleaners 112 (cleaner 112Y for cleaning the photoreceptor 107Y, cleaner 112M for cleaning the photoreceptor 107M, cleaner 112C for cleaning the photoreceptor 107C, and cleaner 112K for cleaning the photoreceptor 107K); a recording material sheet cassette 113, a pickup roller 114, a pair of feeding rollers 115, a pair of registration rollers 116, a feeding belt 117, belt pulleys 118 and 119, a belt charger 120, a sheet separation charger 121, a belt discharger 122, a belt cleaner 123, a fixing device 124, a pair of discharging rollers 125, and a copy tray 126. In this regard, suffixes Y, M, C and k represent yellow, magenta, cyan and black colors.

The optical scanning device 100 includes a light deflector 101, scanning lenses 102 (102A and 102B), light reflecting mirrors 103 (103Y, 103Ma, 103Mb, 103Ca, 103Cb, and 103K), and optical elements 104 (104Y, 104M, 104C, and 104K).

In the laser printer illustrated in FIG. 8, a sheet S of a recording material set in the recording material sheet cassette 113, which is horizontally set on the bottom of the printer, is picked up by the pickup roller 11, and then fed by the pair of feeding rollers 115 toward the feeding belt 117, which is rotated by the belt pulleys 118 and 119 (at least one of which is a driving roller) while tightly stretched thereby. Above the feeding belt 117, the four photoreceptors 107Y, 107M, 107C and 107K are arranged side by side at regular intervals from the upstream side relative to the recording material sheet feeding direction.

The photoreceptors 107 are cylindrical photoreceptors having the same diameter, and process devices for performing respective processes are arranged around each of the photoreceptors. For example, around the yellow-image forming photoreceptor 107Y, the charger 108Y, the beam emitting optical device (such as optical element 104Y) of the optical scanning device 100, the developing device 110Y, the transfer charger 111Y, and the cleaner 112Y are arranged in this order. The other color image forming sections have substantially the same configuration.

In this printer, the peripheral surfaces of the photoreceptors 107 are scanning surfaces, and light beams emitted by the optical scanning device 100 while modulated by Y, M, C and K image information are focused on the peripheral surfaces of the photoreceptors 107Y, 107M, 107C and 107K, which have been charged by the respective chargers 108, to form electrostatic latent images corresponding to yellow, magenta, cyan and black images on the surfaces of the respective photoreceptors 107Y, 107M, 107C and 107K.

The optical scanning device 100 uses a counter scanning method. The single light deflector 101 is used as the light deflector (corresponding to the light deflector 14 mentioned above for use in the first to fifth examples of the optical scanning device of the present invention). The scanning lens 102 (corresponding to the scanning lens 15 mentioned above) includes the scanning lens 102A commonly used for light beams for forming yellow and magenta images, and the scanning lens 102B commonly used for light beams for forming cyan and black images. In addition, the light reflecting minor 103 (corresponding to the light reflecting minors 20-22) includes the light reflecting mirror 103Y for reflecting light beams for forming yellow images toward the photoreceptor 107Y, the light reflecting mirrors 103Ma and 103Mb for reflecting light beams for forming magenta images toward the photoreceptor 107M, the light reflecting minors 103Ca and 103Cb for reflecting light beams for forming cyan images toward the photoreceptor 107C, and the light reflecting minor 103K for reflecting light beams for forming black images toward the photoreceptor 107K. The optical element 104 (corresponding to the optical elements 16 and 17) includes the optical element 104Y, through which light beams for forming yellow images pass, the optical element 104M, through which light beams for forming magenta images pass, and the optical element 104C, through which light beams for forming cyan images pass, and the optical element 104K, through which light beams for forming back images pass.

The pair of registration rollers 116 and the belt charger 120 are provided on an upstream side from the photoreceptor 107Y for forming yellow images relative to the feeding direction of the recording material sheet S fed by the feeding belt 117. In addition, the sheet separation charger 121 is provided on a downstream side from the photoreceptor 107K for forming black images relative to the feeding direction of the recording material sheet S. Further, the dischargers 122, and the cleaner 123 are provided along the feeding belt 117 so as to be located on downstream sides from the sheet separation charger 121 relative to the moving direction of the feeding belt 117. Furthermore, the fixing device 124, the pair of discharging rollers 125, and the copy tray 126 are provided on downstream sides from the sheet separation charger 121 relative to the feeding direction of the recording material sheet S.

When this printer is in a full color mode (multi-color mode), i.e., the printer produces full (multiple) color images, the optical scanning device 100 irradiates the surfaces of the photoreceptors 107Y, 107M, 107C and 107K with light beams according to Y, M, C and K image information to form electrostatic latent images corresponding to the Y, M, C and K images on the respective photoreceptors 107Y, 107M, 107C and 107K. These electrostatic latent images are developed with the respective developing devices 110Y, 110M, 110C and 110K using Y, M, C and K toners, resulting in formation of Y, M, C and K toner images on the surfaces of the respective photoreceptors 107Y, 107M, 107C and 107K. The color toner images are sequentially transferred onto the recording material sheet S, which is fed by the feeding belt 117 while electrostatically attracted thereby, resulting in formation of a combined color toner image on the recording material sheet S. The combined color toner image is then fixed by the fixing device 124, resulting in formation of a fixed full color image on the recording material sheet S. The recording material sheet S bearing the full color image is then discharged by the pair of discharging rollers 125 so as to be stacked on the copy tray 126.

By using the optical scanning device mentioned above for the optical scanning device 100 of the image forming apparatus (full color laser printer), bending of scanning lines and deterioration of wave aberration can be reduced, and therefore the image forming apparatus can form high quality images without causing the misalignment problem.

The above-mentioned plural refracting surfaces (such as the surfaces 15b-1 and 15b-2) arranged side by side in the sub-scanning direction are surfaces of the lens, through which light beams pass to form electrostatic latent images on the respective scanning surfaces. Needless to say, the plural refracting surfaces can be considered to be one surface represented by one formula (i.e., formula representing the profile shape of the surfaces).

### Example 1

A specific example of the above-mentioned first to fifth examples of the optical scanning device will be described in detail by reference to specific numerical data.

In an optical scanning device having such a configuration as illustrated in FIGS. 1-3, light beams having a wavelength of 659 nm are emitted by a light source 11, and the light beams are converted to parallel light fluxes by a coupling lens 12 having a focal length of 27 mm. A cylindrical lens 13, which has a refracting power only in the sub-scanning direction, focuses the parallel light fluxes in the sub-scanning direction in the vicinity of a reflection/deflection surface of a light deflector 14, which has four reflection/deflection surfaces and whose inscribed circle has a radius (A) of 7 mm. In this regard, the cylindrical lens 13 is a resin lens, which has a refractive index of 1.5271 against light with a wavelength of 659 nm (in contrast, the coupling lens 12 has a refractive index of 1.6894 against light with a wavelength of 659 nm) and which has a diffractive surface having a function to correct change of the focal position, which is caused by change of temperature, only in the sub-scanning direction. The reason why the cylindrical lens 13 is provided to correct change of the focal position, which is caused by change of temperature, is that the scanning lens 15 has a high magnification in the sub-scanning direction. By using such a coupling lens, the optical scanning device can have good optical property.

The light beams emitted by the light source 11 have an oblique incidence angle of 1° against the normal line (n) of the reflection/deflection surface of the light deflector 14. Namely, two light beams used for forming electrostatic latent images on different scanning surfaces are obliquely incident on the reflection/deflection surface at angles of +1° and −1°. In this regard, the light beams are incident on the reflection/deflection surface at an angle of 68° in the main scanning direction relative to the normal line (n) of the reflection/deflection surface.

In this example, two coupling lenses are used for two light beams, and one cylindrical lens is commonly used for the two light beams.

In this example, the distance between the rotation axis of the light deflector 14 and the light entering surface of the scanning lens 15 is 40.9 mm, the thickness of the scanning lens 15 is 14 mm, and the distance between the rotation axis of the light deflector 14 and the scanning surfaces is 210 mm. Optical elements 16 and 17, which do not have a refracting power in both the main and sub scanning directions and which have a thickness of 1.9 mm, are arranged at locations apart from the scanning surfaces by 90 mm. The scanning lens 15 has a refractive index of 1.5271 against light with a wavelength of 659 nm.

In this example, which has such a configuration as illustrated in FIG. 1-3, two light beams irradiate two different scanning surfaces (18 and 19). Therefore, the scanning lens 15 is constituted of one lens and is commonly used by the two light beams. The light entering surface of the scanning lens 15 is a flat surface having no curvature in the sub-scanning direction, and the light exiting surface 15b thereof is constituted of two surfaces 15b-1 and 15b-2, which are arranged side by side in the sub-scanning direction and each of which has a positive refracting powering the sub-scanning direction. The surfaces 15b-1 and 15b-2 have the same shape. The surfaces 15b-1 and 15b-2 will be described later in detail.

Light beams to irradiate different scanning surfaces 18 and 19 are incident on a reflection/deflection surface of the light deflector 14 in such a manner that the light beams have oblique incidence angles of +1° and −1° and are symmetry relative to a symmetry plane, which is mentioned later. The distance in the sub-scanning direction between two reflection points of the light beams on the reflection/deflection surface is about 2.5 mm, and the thickness of the light deflector 14 in the sub-scanning direction is 4 mm.

The plural lens surfaces 15b-1 and 15b-2 are arranged so as to be symmetric in the sub-scanning direction about a symmetry plane, which extends in the main scanning direction while including a midpoint of the reflection points of two light beams on the reflection/deflection surface of the light deflector 14 and the normal line (n) of the reflection/deflection surface. In addition, the clusters of vertices of profile lines V1 and V2 (i.e., generatrices P1 and P2 (or reference axes)) of each of the lens surfaces 15b-1 and 15b-2 are shifted toward the symmetry plane (i.e., the center of the scanning lens 15 in the sub-scanning direction), so that the distance between the generatrices P1 and P2 and the symmetry plane is 2.03 mm. In this regard, the distance between the intersections of light beams with the lens surfaces 15b-1 and 15b-2 and the generatrices P1 and P2 is about 0.5 mm at the center of the scanning lens in the main scanning direction, namely the distance between the intersections and the symmetry plane is about 2.5 mm (2.03+0.5) at the center of the scanning lens.

The shapes of the light entering surface 15a and the light exiting surface 15b of the scanning lens 15 used for this example are described in Table 1 below. Table 1 shows a case where a light beam reflected by the light deflector passes through the lower portion (i.e., portion including the surface 15b-2) of the scanning lens 15. In this regard, the light entering surface 15a is a flat surface having no curvature in the sub-scanning direction.

TABLE 1
Shape of surfaces of scanning lens 15

| | Light entering surface 15a | Light exiting surface 15b |
|---|---|---|
| RY | 159.609 | −172.416 |
| K | 0 | 0 |
| A | −5.4474 × 10⁻⁶ | −3.2811 × 10⁻⁶ |
| B | 1.3636 × 10⁻⁸ | 5.4646 × 10⁻⁹ |
| C | −2.3989 × 10⁻¹¹ | −5.2557 × 10⁻¹² |
| D | 2.2631 × 10⁻¹⁴ | 1.1614 × 10⁻¹⁵ |
| E | −1.0813 × 10⁻¹⁷ | 9.4646 × 10⁻¹⁹ |
| F | 2.0560 × 10⁻²¹ | −4.2716 × 10⁻²² |
| RZ | ∞ | −18.282 |
| a | — | −1.6100 × 10⁻⁶ |
| b | — | 1.1461 × 10⁻⁵ |
| c | — | −1.4140 × 10⁻⁸ |
| d | — | −1.5712 × 10⁻⁸ |
| e | — | 2.6274 × 10⁻¹¹ |
| f | — | 2.5864 × 10⁻¹¹ |
| g | — | −2.6426 × 10⁻¹⁴ |
| h | — | −2.7098 × 10⁻¹⁴ |
| i | — | 9.6938 × 10⁻¹⁸ |
| j | — | 9.9202 × 10⁻¹⁸ |

The light exiting surface 15b is a surface in which the curvature thereof in the sub-scanning direction changes in the main scanning direction, and the shape of the surface can be represented by the following formula (1):

$$X ( Y , Z ) = \frac{{Y}^{2} \cdot Cm}{1 + \sqrt{1 - ( 1 + K ) \cdot {( Y \cdot Cm )}^{2}}} + A \cdot {Y}^{4} + B \cdot {Y}^{6} + C \cdot {Y}^{8} + D \cdot {Y}^{10} + E \cdot {Y}^{12} … + \frac{Cs ( Y ) \cdot {Z}^{2}}{1 + \sqrt{1 - {\{ Cs ( Y ) \cdot Z \}}^{2}}} \\ Cm = 1 / RY \\ Cs ( Y ) = ( 1 / RZ ) + aY + {bY}^{2} + {cY}^{3} + {dY}^{4} + {eY}^{5} + {fY}^{6} + {gY}^{7} + {hY}^{8} + {iY}^{9} + {jY}^{10} … \qquad ( 1 )$$

wherein RY represents the paraxial curvature radius of a main scanning cross-section, which is a cross-section parallel to the main scanning direction, Y represents the distance in the main scanning direction from the reference axis, Z represents the distance in the sub-scanning direction from the reference axis, A, B, C, D . . . represent high order coefficients, and RZ represents the paraxial curvature radius of a sub-scanning cross-section, which is a cross-section perpendicular to the main scanning cross-section.

In this regard, the reference axis of each surface is defined as the normal line at the origin of the equation, and is parallel to the symmetry plane mentioned above.

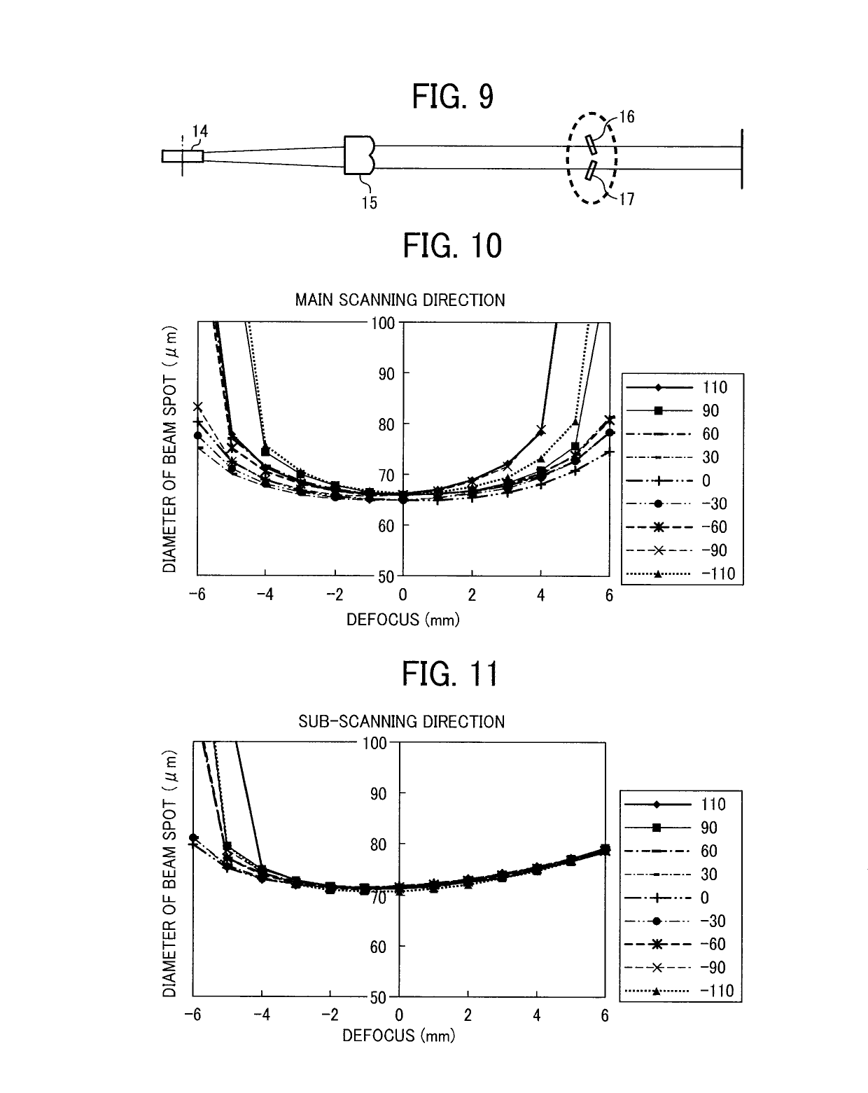

The optical elements 16 and 17, which are arranged between the scanning lens 15 and the scanning surfaces 18 and 19 and which have no refracting power in the main scanning and sub-scanning directions, are set so as to be tilted at an angle of 14° in the sub-scanning direction against the incident light beam as illustrated in FIG. 9. In FIG. 9, the optical members used for emitting light beams and allowing the light beams to be incident on the light deflector 14, and the light reflecting mirrors used for guiding the light beams to the scanning surfaces are not illustrated. In FIG. 9, light beams are incident on the light deflector 14 in a direction of from the backside of a paper sheet, on which FIG. 9 is printed, to the front side of the paper sheet.

FIGS. 10 and 11 illustrate the diameters of beam spots formed by this optical scanning device. It is clear from FIGS. 10 and 11 that the beam spots have no deviation even when the image height changes. Specifically, FIG. 10 illustrates the diameters of beam spots in the main scanning direction when the image height is changed at nine levels (±110, ±90, ±60, ±30, 0), and FIG. 11 illustrates the diameters of beam spots in the sub-scanning direction when the image height is changed at the nine levels. Namely, the wave aberration is satisfactorily corrected. In this example, a rectangular aperture having a length of 2.3 mm in the main scanning direction and a length of 2.1 mm in the sub-scanning direction is arranged between the coupling lens 12 and the cylindrical lens 13 having a refracting power only in the sub-scanning direction to form a beam spot.

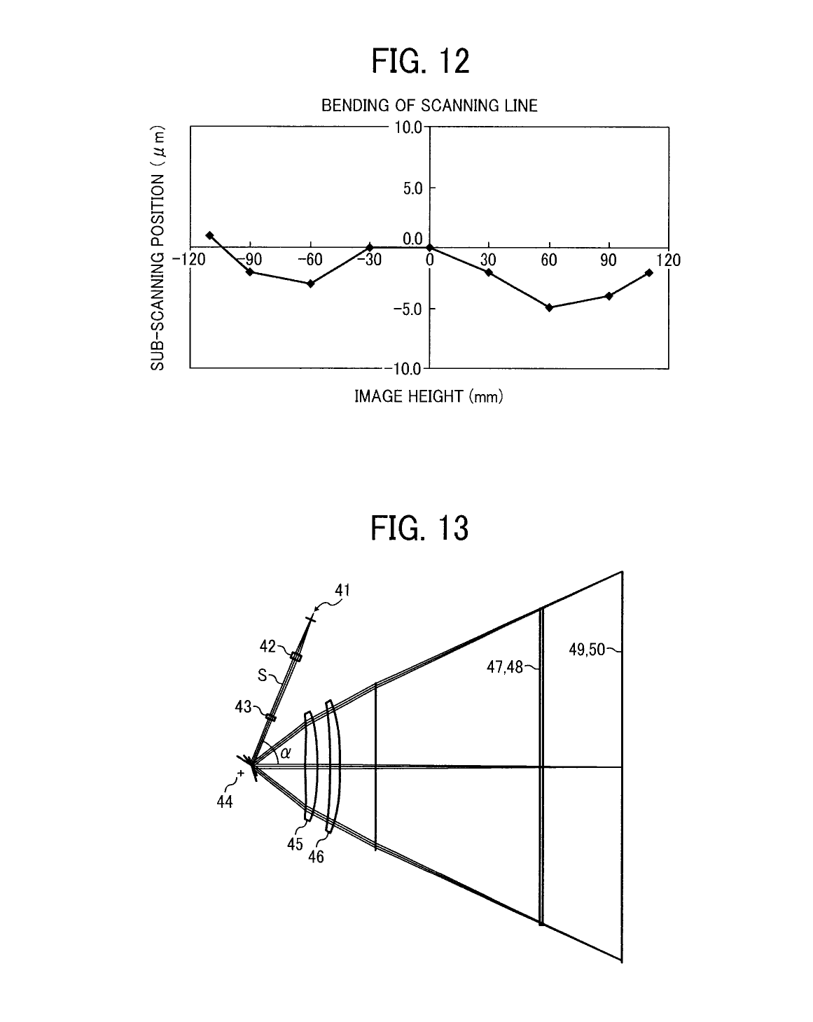

In addition, as illustrated in FIG. 12, bending of a scanning line is as small as about 5 μm. The bending of a scanning line is defined as the PV value (Peak-Valley value) in the sub-scanning direction of a scanning line formed on a scanning surface. In FIG. 12, the image height means the position on the scanning surfaces 18 and 19 in the main scanning direction, and the plus sign (+) and minus sign (−) respectively mean the upper and lower sides of the scanning surfaces in FIG. 1,

By setting the optical scanning device of this example on both sides of a polygon scanner, which serves as the light deflector 14 and which is commonly used by the optical scanning devices, it becomes possible to scan four different scanning surfaces.

Namely, such an optical scanning device can be preferably used as the optical scanning device of a full color image forming apparatus, which can produce full color images (Y, M, C and K images).

Next, other examples of the optical scanning device and image forming apparatus of the present invention will be described by reference to FIGS. 13-23.

Next, another example of the optical scanning device will be described.

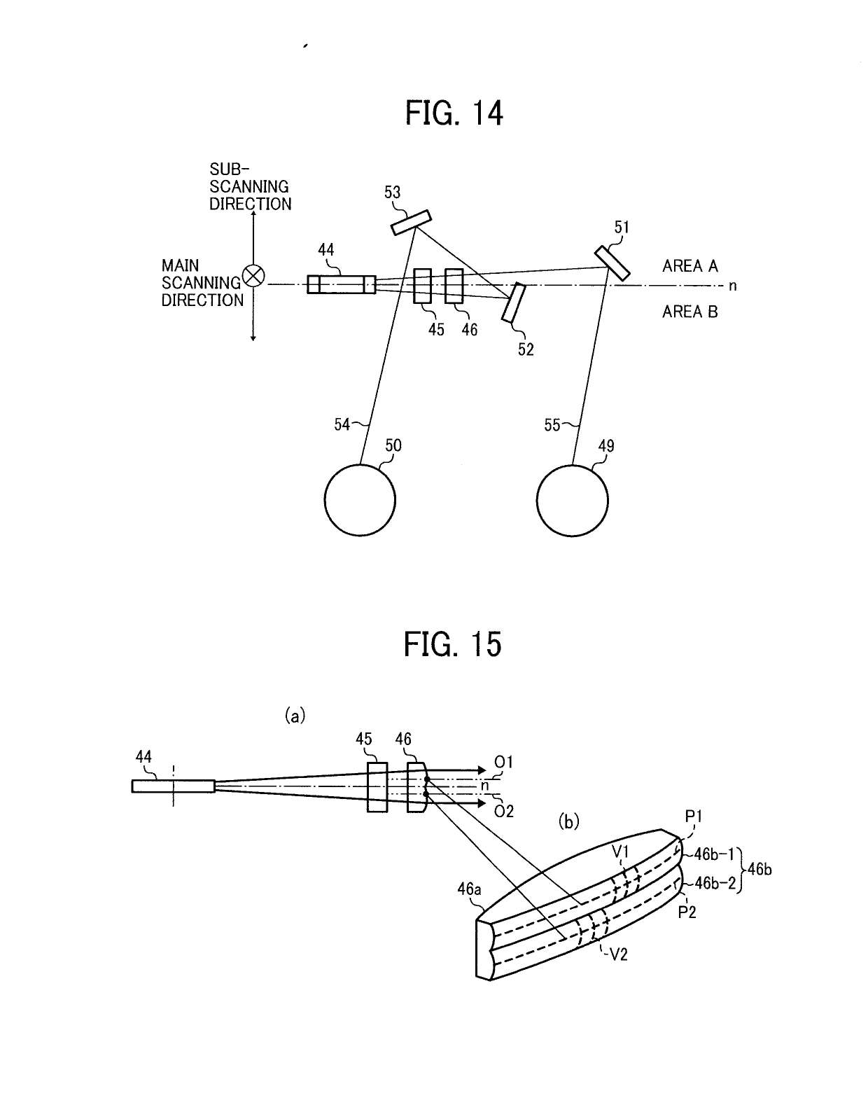

The number of the scanning lens is not limited to one, and a combination of two scanning lenses can also be used. FIGS. 13-16 illustrate a main portion of the example of the optical scanning device. FIG. 13 is a schematic plan view illustrating the structure of the main portion of the optical scanning device in the main scanning direction, and FIG. 14 is a schematic side view illustrating the structure of the main portion of the optical scanning device in the sub-scanning direction. FIG. 15(a) is a schematic side view illustrating the scanning lens of the optical scanning device, and FIG. 15(b) is a schematic perspective view illustrating the scanning lens.

The optical scanning device illustrated in FIGS. 13-15 includes a light source 41, a coupling lens 42, a cylindrical lens 43, a light deflector 44, a combination of two scanning lenses 45 and 46, optical elements 47 and 48, photoreceptors (scanning surfaces) 49 and 50, and light reflecting mirrors 51, 52 and 53.

The oblique incidence type optical scanning device will be described by reference to FIGS. 13 and 14.

Specific examples of the light source 41 include laser diodes. A divergent light flux emitted by the light source 41 is converted by the coupling lens 42 to a light flux suitable for the following optical system. The thus converted light flux is a parallel light flux, a slightly divergent light flux, or a slightly convergent light flux.

The light flux passing through the coupling lens 42 and a rectangular aperture S is condensed in the sub-scanning direction by the cylindrical lens 43, and is incident on a rotating reflection/deflection surface of the light deflector 44. Specific examples of the light deflector 44 include polygon mirrors having multiple peripheral surfaces serving as reflection/deflection surfaces. In this regard, the light flux passing through the cylindrical lens 43 is incident on the reflection/deflection surface at an oblique angle in the sub-scanning direction relative to a normal line (n) as illustrated in FIG. 14. Such an obliquely incident light flux can be formed by slanting the light source 41, the coupling lens 42 and the cylindrical lens 43 at a predetermined angle, or by using a light reflecting mirror to change the angle of the light flux. Alternatively, it is possible to shift the optical axis of the cylindrical lens 43 in the sub-scanning direction so that the light beam passing through the cylindrical lens 43 proceeds to the reflection/deflection surfaces of the light deflector 44 at an angle.

The light fluxes incident on the reflection/deflection surface of the light deflector 44 are subjected to deflection scanning with constant acceleration by the polygon mirror, which is rotated with constant acceleration, to scan the scanning surfaces of the photoreceptors 49 and 50 after passing through the scanning lenses 45 and 46. The light fluxes deflected from the reflection/deflection surface are focused on the scanning surfaces, thereby forming light spots on the scanning surfaces while scanning the light spots.

In FIG. 13, character α denotes the angle of a light beam incident on the reflection/deflection surface of the light deflector 44 in the main scanning direction relative to the normal line of the scanning surface. In this example, α is 68°.

Next, the feature of the optical system of the optical scanning device of the present invention will be described by reference to a case where the optical scanning device is used for tandem color image forming apparatuses.

FIG. 14 illustrates an example of the optical scanning device of the present invention to scan two scanning surfaces. Light beams emitted by plural light sources 41 (not shown in FIG. 14) are obliquely incident on the same one of the reflection/deflection surfaces of the light deflector 44. Specifically, light beams are obliquely incident on the reflection/deflection surface from both sides of the normal line (n) of the reflection/deflection surface relative to the sub-scanning direction (i.e., from areas A and B), and then reflected toward the opposite sides (i.e., toward areas B and A). After passing through the common scanning lenses 45 and 46, the light beams are separated from each other by a combination of light reflecting mirrors 52 and 53, and a light reflecting mirror 51 so as to be guided to the scanning surfaces of the photoreceptors 49 and 50 after passing through the optical elements 47 and 48.

In this example, the number of reflecting mirrors to reflect a light beam, which is incident on the reflection/deflection surface from the area A and reflected toward the area B, is odd (in the example illustrated in FIG. 14, the number of reflecting mirrors is one (i.e., the light reflecting mirror 51)). In contrast, the number of reflecting mirrors to reflect a light beam, which is incident on the reflection/deflection surface from the area B and reflected toward the area A, is even (in the example illustrated in FIG. 14, the number of reflecting mirrors is two (i.e., the light reflecting mirrors 52 and 53)). In this regard, the light beams illustrated in FIG. 14 are light beams reflected from and deflected by the light deflector 44, and the incident light beams thereof (which are not illustrated in FIG. 14) are incident on the deflector from the opposite areas in the sub-scanning direction. Thus, by arranging light reflecting mirrors 51-53, the directions of the scanning lines formed by the light beams, which bending is caused by an oblique incidence type optical system, can be identical to each other, thereby reducing the degree of the misalignment of color images.

By using such a light deflector (light deflector 44) in which light beams from plural light sources are obliquely incident on reflection/deflection surfaces thereof relative to the normal line (n) of the reflection/deflection surfaces, the length of the light deflector in the sub-scanning direction can be decreased, thereby making it possible that the costs of the light deflector, which has a relatively high cost compared to other parts constituting the optical scanning device, can be reduced so as to be lower than that of a light deflector used for an optical scanning device, in which light beams are incident in a direction parallel to the normal line (n) of the light deflector. In addition, since the light deflector 44 can be miniaturized, power consumption and noise of the light deflector can be reduced, thereby making it possible to provide an environmentally friendly optical scanning device with low costs. Hereinafter, the angle of light beams relative to the normal line (n) is sometimes referred to as an oblique incidence angle.

In this example, the scanning lenses 45 and 46 are commonly used for all the light beams 54 and 55, which are reflected from the same deflection/reflection surface of the polygon mirror 44. Therefore, the number of parts of the optical elements can be reduced, thereby reducing the costs of the optical scanning device.

Further, in order to reduce the number of parts and the costs of the optical scanning device, the scanning lenses 45 and 46 are commonly used for all the light beams reflected from the same reflection/deflection surface. Conventional optical scanning devices typically have a configuration such that plural scanning lenses are overlaid in the sub-scanning direction. In contrast, the scanning lenses 45 and 46 can have a configuration such that plural lens surfaces are arranged so as to be close to each other in the sub-scanning direction, thereby making it possible to reduce the oblique incidence angle, and to decrease the size of the scanning lens. Particularly, by reducing the oblique incidence angle, a large effect can be produced as mentioned later. In addition, unlike conventional optical scanning devices in which scanning lenses are used for respective scanning surfaces, the optical scanning device of this example has good flexibility in designing the layout thereof, thereby making it possible to miniaturize the optical scanning device.

Oblique incidence type scanning systems tend to cause a problem in that the wave aberration often deteriorates. Unless the light entering surface of the scanning lens thereof has a shape of arc in the main scanning direction, whose center is the light reflection point on the reflection/deflection surface of the light deflector thereof, the distance between the reflection/deflection surface of the light deflector and the light entering surface of the scanning lens changes depending on the image height (i.e., the distance changes in the main scanning direction). In general, it is difficult to prepare a scanning lens having such a light entering surface because the optical property of the lens deteriorates.

Namely, it is difficult for a light beam deflected by a light deflector to vertically enter the light entering surface of a scanning lens at any image height in the main scanning direction, and the light beam enters the light entering surface at an angle. A light flux of light beams reflected and deflected by a light deflector has a certain width in the main scanning direction, and therefore light beams on both ends (in the main scanning direction) of a light flux have different traveling lengths when traveling from the reflection/deflection surface of the light deflector to the light entering surface of a scanning lens. In addition, since the light beams obliquely enter the reflection/deflection surface, the light beams have an angle in the sub-scanning direction, and therefore the light beams enter the scanning lens while twisted. When the light flux thus twisted enters the scanning lens, which has a strong refracting power in the sub-scanning direction, the wave aberration increases. Namely, the light flux enters the scanning lens having a strong refracting power in the sub-scanning direction while skewing, and the light beams of the light flux on both the sides thereof in the main scanning direction are differently refracted. Therefore, the light beams are not focused on one point of the scanning surface. Namely, since the wave aberration deteriorates, the beam spot diameter widens.

As illustrated in FIG. 13, the incidence angle in the main scanning direction of light entering the scanning lenses 45 and 46 increases as the light entering point is apart from the center of the scanning lenses. Therefore, the light entering points of light beams on both the ends of a light flux are largely different from each other in the sub-scanning direction, i.e., the light flux is largely twisted, and the beam spot seriously increases as the light entering point approaches the end portion of the scanning lens in the main scanning direction.

In addition, oblique incidence type scanning systems have a disadvantage over conventional lateral incidence type scanning systems that bending of a scanning line is larger. The amount of bending of a scanning line formed by a light beam depends on the incidence angle (in the sub-scanning direction) of the light beam. Therefore, when electrostatic latent images formed by different light beams to form different visible color images are developed with different color developers, the misalignment problem in that the positions of the visible color images are different from each other is caused.

For example, when the light entering surface of a scanning lens, which has strong refracting power in the sub-scanning direction, has a shape of arc in the main scanning direction, whose center is the light reflection point on the reflection/deflection surface of a light deflector, the distance between the reflection/deflection surface of the light deflector and the light entering surface of the scanning lens is constant independently of the light entering position on the scanning lens in the main scanning direction (i.e., image height), and therefore the distance does not change when performing scanning. However, in general, it is difficult for the scanning lens to have such a shape because the optical property of the lens deteriorates. Namely, it is difficult for light beams deflected by a light deflector to vertically enter the light entering surface of a scanning lens at any position (image height) in the main scanning direction, and light beams enter the light entering surface at an angle as illustrated in FIG. 13.

Thus, since light beams have an angle in the sub-scanning direction because of being subjected to oblique incidence, the light paths of the light beams between the reflection/deflection surface of the light deflector 44 and the light entering surface of the scanning lens 45 change depending on the image height (i.e., the light entering position on the scanning lens in the main scanning direction). Specifically, as the light entering position is apart from the center of the scanning lens 45 in the main scanning direction, the light entrance position in the sub-scanning direction becomes higher or lower in the sub-scanning direction than that at the center of the scanning lens 45. In this regard, whether the light entrance position in the sub-scanning direction becomes higher or lower depends on the direction of the incidence angle of the light beam.

Accordingly, when light beams pass through the surface having a refracting power in the sub-scanning direction, the refracting powers that the light beams receive are different, thereby causing bending of the scanning line. In horizontal incidence type scanning systems, light beams proceed horizontally to a scanning lens, and therefore the light entering positions in the sub-scanning direction do not change and bending of a scanning line is not caused even when the distance between the reflection/deflection surface of a light deflector and the light entering surface of a scanning lens changes.

In the example of the optical scanning device illustrated in FIG. 15, the scanning lens 45, which is used for all the light beams reflected and deflected by the same reflection/deflection surface of the light deflector 44, has a structure such that one surface thereof (in this example a surface 46b closer to the scanning surfaces 49 and 50) has plural surfaces 46b-1 and 46b-2 each having a positive refracting power, and the generatrices P1 and P2, which are a cluster of vertices of profile lines V1 and V2 of the lens surfaces, are present in planes parallel to the normal line (n) of the reflection/deflection surface of the light deflector 44. In this regard, a surface 46a of the scanning lens 46 opposite to the surface 46b is flat in the sub-scanning direction, and is parallel to the rotation center of the polygon mirror (light deflector). In contrast, the surfaces of the scanning lens 45 are flat in the sub-scanning direction. The scanning lenses 45 and 46 are arranged so as to be parallel to the reflection/deflection surface of the light deflector 44.

In general, in optical scanning devices, the reflection/deflection surface of the light deflector and a scanning surface have conjugated relation with each other. Therefore, when the scanning lenses 45 and 46 are arranged as described above, the deviation of magnification in the sub-scanning direction can be decreased at any positions of the scanning lenses in the main scanning direction, i.e., the magnification in the sub-scanning direction can be substantially constant, thereby making it possible to correct bending of the scanning line. This is because the distances between the optical axes (O1 and O2 in FIG. 15) of the scanning lenses 45 and 46 and the light reflection point on the reflection/deflection surface of the light deflector 44 are constant (i.e., the height of object is constant), and therefore the image can be formed at points having the same distances from the optical axes O1 and O2 in the main scanning direction. In this example, since the light entering surfaces of the scanning lenses 45 and 46 are flat, the normal line at the origin of the formula showing the profile of the light exiting surface of the scanning lens is defined as an optical axis as illustrated in FIG. 15. The optical axes O1 and O2 are parallel to the normal line (n) of the reflection/deflection surface of the light deflector 44, and the number of the optical axes (O1 and O2) is equal to the number of the light exiting surfaces (46b-1 and 46b-2) of the scanning lens 46.

In order to reduce deviation of magnification in the sub-scanning direction, it is effective to use a surface, in which the curvature thereof in the sub-scanning direction is changed in the main scanning direction, as well as making field curvature correction. However, when a light beam passes a position (i.e., off-axis position) far apart from an optical axis of the scanning lens in the sub-scanning direction, the influence of aberration is enhanced, thereby making it impossible that the image height is constant in the main scanning direction. Therefore, it is preferable that light beams pass near the optical axes.

In addition, in optical scanning devices for use in color image forming apparatuses, it is possible to reduce the degree of misalignment of color images, which is caused by bending of scanning lines, by setting a moderate number of light reflecting mirrors to control the direction of bending so as to be the same as mentioned above. Needless to say, when bending of scanning lines is large, the quality of images deteriorates. However, by using the optical scanning device of the present invention, high quality images can be produced.

In addition, correction of wave aberration is a problem to be solved in oblique incidence type scanning systems as well as correction of scanning line bending. In this example, the surfaces 46b-1 and 46b-2 allow the light beams, which pass through the respective surfaces, to change the traveling directions toward the centers of the scanning lenses 45 and 46 in the sub-scanning direction, thereby correcting wave aberration.

Thus, in this example, the surface of the scanning lens 46 is subjected to shift decentering so that a chief ray of light beams proceeding toward an end portion (in the main scanning direction) of an oblique incidence type scanning system, which portion has greatly deteriorated wave aberration, proceeds in substantially parallel with the normal line of the reflection/deflection surface of the light deflector 44 after exiting the scanning lenses 45 and 46, and thereby coma aberration is corrected, resulting in satisfactory correction of wave aberration. In this regard, the chief ray of a light beam (light flux) means a ray passing through the center of a light path which is formed by an aperture or the like. In addition, the shift decentering means that the surfaces 46b-1 and 46b-2 are decentered toward the center of the scanning lens 46 in the sub-scanning direction so that a chief ray of light beams proceeding toward an end portion in the main scanning direction proceeds in substantially parallel with the normal line of the reflection/deflection surface of the light deflector 44 after exiting the scanning lens 46.

In this case, a light beam proceeding in the vicinity of the optical axis of the scanning lens 46 in the main scanning direction has an angle in the sub-scanning direction after exiting the light exiting surface of the scanning lens. However, since wave aberration caused by skew of a light flux is little, a problem concerning optical property does not occur. In addition, the amount of shift decreases as the oblique incidence angle decreases. Therefore, even when the surface of the scanning lens 46 is subjected to shift decentering, influence on correction of bending of a scanning line mentioned above is little when the oblique incidence angle is not greater than 5°. Therefore, it is possible to solve the problems specific to the oblique incidence type scanning system, i.e., deterioration of wave aberration and bending of a scanning line, at the same time. In this regard, detailed description will be made later by reference to several specific examples, and results such that when wave aberration is corrected, a beam spot having a desirable diameter can be obtained, and in addition bending of a scanning line can be controlled so as to be small (about 19 μm) are obtained in the examples.

In this example, the scanning lens 46 has plural lens surfaces (i.e., the surfaces 46b-1 and 46b-2 illustrated in FIG. 15), which are arranged side by side in the sub-scanning direction. In order that the scanning lenses have a function to focus light beams on a scanning surface, it is possible each of the lenses has only one lens surface, which is commonly used for plural light beams. However, as mentioned above, in order to correct wave aberration by subjecting the lens surface to shift decentering in the sub-scanning direction depending on the oblique incidence angles of light beams entering the scanning lenses, it is necessary to change the positions of the generatrices P1 and P2 of the lens 46 in the sub-scanning direction for each light beam. Therefore, it is necessary for the scanning lenses to have plural lens surfaces to be used for plural light beams. When the scanning lens has plural lens surfaces, it becomes possible that light beams pass in the vicinity of the summits of the generatrices of the lens surfaces having a positive refracting power, namely, light beams do not pass points far apart from the generatrices of the lens surfaces, thereby making it possible to correct bending of a scanning line while reducing influence of aberration.

As mentioned above, in order to correct bending of scanning lines and wave aberration, it is necessary to subject the lens surfaces to shift decentering in the sub-scanning direction depending on the oblique incidence angles of light beams. In this regard, in order to subject the lens surfaces to shift decentering in a proper amount, it is better to pass light beams through different lens surfaces than to pass light beams through a common lens surface because such lens surfaces have better flexibility and optical property.

In addition, when a scanning lens having a power in the sub-scanning direction is subjected to decentering in the sub-scanning direction, the lens has an asymmetric shape in the sub-scanning direction. In this regard, it is necessary that the scanning lens surfaces of the lens have reverse shapes relative to the sub-scanning direction to properly transmit the light beams, which enter the lens from the areas A and B illustrated in FIG. 14. In a conventional case where this structure is established using the same two lenses, it is necessary that one of the lenses is rotated by 180° in the sub-scanning direction. In this case, the lenses are reversed by 180° in the main scanning direction and the sub-scanning direction. Namely, unless the lenses have a symmetric shape in the main scanning direction, the lenses cannot be used for this purpose. However, it is important to use a lens having an asymmetric shape in the main scanning direction, because the lens has good optical property. Therefore, it is necessary to use two different lenses, which are reversed only in the sub-scanning direction, for the scanning lens instead of the same two lenses. In this case, the costs of the scanning lens seriously increase because the development costs, the administration costs, and the parts costs thereof increase.

In contrast, in the optical scanning device of the present invention, a scanning lens, which is a layered scanning lens having plural lens surfaces, is commonly used for each light beam, and therefore the optical scanning device can have good optical property without increasing the costs.

Next, another example of the optical scanning device of the present invention will be described.

This example has good flexibility in designing the optical layout of the portion of from a light deflector to a scanning surface. In particular, in order to reduce the size of the optical scanning device in the sub-scanning direction, the optical scanning device of this example has a configuration such that a common scanning lens is arranged in the vicinity of a light deflector.

As mentioned above, an oblique incidence type optical system causes the problem such that variation in the interval between scanning lines in the sub-scanning direction increases due to variation of the reflection/deflection surfaces of the light deflector 44 (polygon mirror).

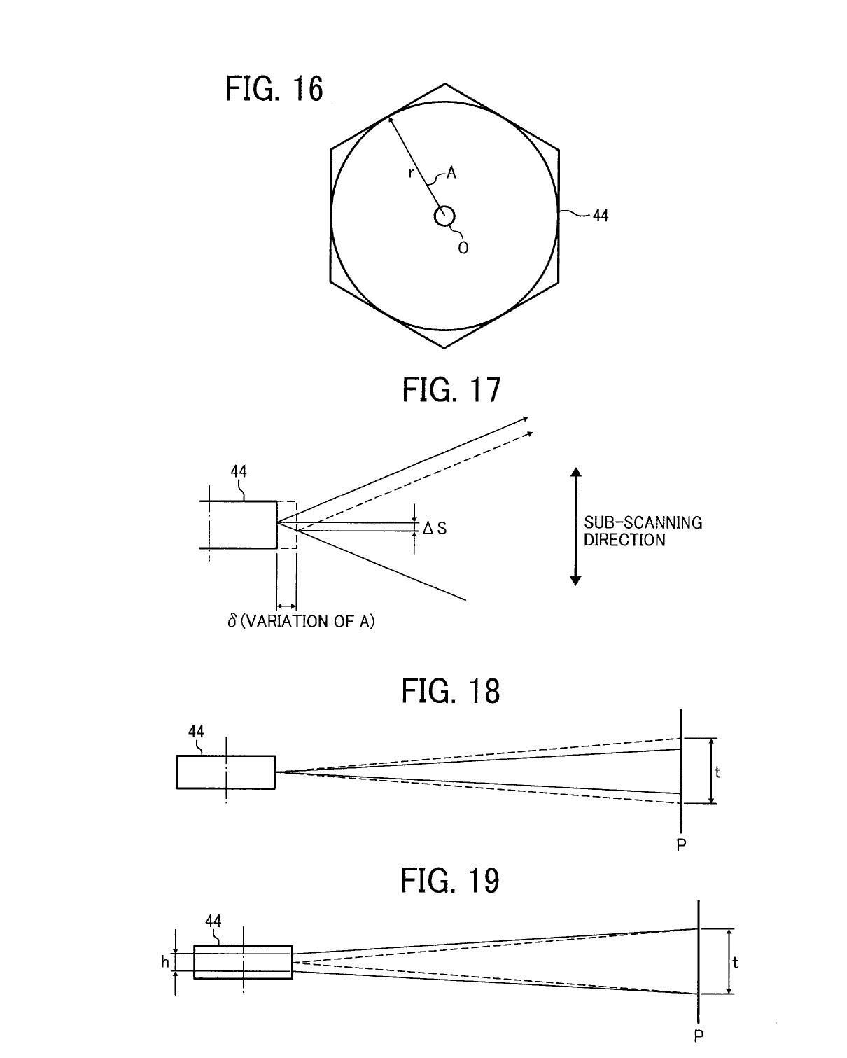

In the polygon mirror of the light deflector 44 illustrated in FIG. 16, the length of a perpendicular connecting a rotation center O of the polygon mirror and one of plural mirror surfaces (i.e., reflection/deflection surfaces), which is a radius r of the inscribed circle of the polygon mirror, is defined as A. When the length A varies for the plural mirror surfaces, the reflection point varies in the sub-scanning direction in an amount of ΔS as illustrated by a solid line and a broken line in FIG. 17, and therefore the focusing point on a scanning surface also varies in the sub-scanning direction in an amount of δ. In general optical scanning systems which are not an oblique incidence type scanning system, the reflection point does not vary even when the length A varies, and therefore the focusing point on the scanning surface does not vary in the sub-scanning direction.

In addition, in the optical scanning device of the present invention, in order to enhance the flexibility in designing the layout of the device while reducing the size and costs of the device, the magnification is high as mentioned above. Accordingly, when the reflection point varies in the sub-scanning direction, the variation is enlarged on a scanning surface. Namely, the problem in that the reflection point varies in the sub-scanning direction is specific to the oblique incidence type scanning system, particularly, the oblique incidence type scanning system in which the magnification of the scanning optics in the sub-scanning direction is high. When the light deflector uses a polygon mirror having six reflection/deflection surfaces and the length A for the reflection/deflection surfaces varies, the positions of scanning lines varies in the sub-scanning direction at a cycle of six lines, thereby seriously deteriorating the image quality.

In particular, in a case where a scanning lens is set in the vicinity of a light deflector in order to reduce the number of scanning lenses used and the size of the optical scanning device, magnification (in the sub-scanning direction) of a scanning optics set between the reflection/deflection surface of the light deflector and a scanning surface, which have conjugated relation, is high. When magnification is high in an oblique incidence type scanning system, not only a problem in that variation in position of a focused image on a scanning surface, which is caused by variation in shape of optical elements used for a normal optical system of the optical scanning device and assembling errors of the optical elements, increases, but also the above-mentioned problem in that the positions of scanning lines largely vary in the sub-scanning direction at a cycle of six lines occurs.

Therefore, in the optical system of this example of the optical scanning device of the present invention, the scanning lens 46 has a positive refracting power in the sub-scanning direction, and the surfaces of the scanning lens closer to scanning surfaces are decentered in the sub-scanning direction. As a result, it becomes possible to reduce magnification of the scanning optics in the sub-scanning direction and to reduce variation in position of scanning lines in the sub-scanning direction caused by variation in the length A of the reflection/deflection surfaces of the polygon mirror.

In order to further reduce magnification, a method in which the scanning lens is set apart from the light deflector can be used. However, when the length of the light path from the light deflector to the scanning surface is constant, the field angle increases, and it becomes impossible to maintain good optical property. In a case where the field angle is not increased, the length of the light path has to be increased, resulting in increase in size of the optical scanning device.

In order to reduce magnification of the scanning optics in the sub-scanning direction to the utmost limit while preventing occurrence of such problems, it is preferable that lens surfaces having positive refracting power are set at a location closer to the scanning surface.

Next, another example of the optical scanning device of the present invention will be described. The configuration of this ninth example is substantially the same as those of the first, second, seventh and eighth examples of the optical scanning device mentioned above.

Another method for reducing variation in intervals between scanning lines in the sub-scanning direction, which is caused by variation in the length A of the polygon mirror of the light deflector 44, is to decrease the oblique incidence angle. By decreasing the oblique incidence angle, variation (ΔS in FIG. 17) in position of the light reflection point on the reflection/deflection surfaces of the polygon minor, which is caused by variation in the length A of the polygon mirror, can be decreased, thereby making it possible to reduce the variation in intervals between scanning lines in the sub-scanning direction.

However, when the oblique incidence angle is low, it becomes hard to separate light beams to an extent such that the separated light beams can irradiate the scanning surfaces of the photoreceptors 49 and 50 after passing through the scanning lenses 45 and 46 as illustrated in FIG. 18. Specifically, in order to separate the light beams to an extent (i.e., an interval (t)) such that it is possible to set light reflecting mirrors for guiding the light beams to the scanning surfaces of the photoreceptors 49 and 50, it is preferable that the oblique incidence angle is as high as possible because the light reflecting mirrors can be set at locations closer to the light deflector 44. In this case, the size of the optical scanning device can be decreased. When the oblique incidence angle is low, a proper interval cannot be formed between the light beams, thereby causing a problem in that the light reflecting mirrors cannot be set in the vicinity of the light reflector 44.

The scanning lens 46 of the optical scanning device of the present invention has plural convex surfaces (46b-1 and 46b-2 in FIG. 15), which have a positive refracting power and which are arranged side by side in the sub-scanning direction while located on the scanning surface side relative to the light traveling direction. The opposite surface of the scanning lens 46 is flat in the sub-scanning direction. Since the convex surfaces 46b-1 and 46b-2, which may have the same shape, are independent from each other, it is necessary for the main rays of the light beams passing the convex surfaces to have a predetermined interval in the sub-scanning direction. In this regard, since the light beams have respective oblique incidence angles to be separated from each other, the interval between the light beams in the sub-scanning direction increases as the light beams approach the scanning surfaces. Namely, since the scanning lens 46 has a configuration such that the lens surface 46b closer to the scanning surfaces (i.e., photoreceptors 49 and 50) have convex surfaces (46b-1 and 46b-2) arranged side by side in the sub-scanning direction, and the other surface closer to the light deflector 44 is flat in the sub-scanning direction so as to be used for all light beams, it becomes possible to decrease the oblique incidence angles of light beams. Since the surface of the scanning lens 46 which is flat in the sub-scanning direction is a common surface for all of plural light beams, it is not necessary to separate the chief rays of the light beams at certain intervals in the sub-scanning direction.

In this regard, it is preferable that the common surface of the scanning lens 46, which is flat in the sub-scanning direction, is parallel to the rotation axis of the polygon mirror of the light reflector 44, and is perpendicular to the normal line (n) of the reflection/deflection surfaces of the light deflector 44. If the common surface of the scanning lens 46 has tilt eccentricity in the sub-scanning direction, it is difficult to control the sub-scanning direction magnification so as to be the same in the main scanning direction, resulting in enhancement of bending of a scanning line.

Next, another example of the optical scanning device of the present invention will be described. The configuration of this tenth example is substantially the same as those of the first to third and seventh to ninth examples of the optical scanning device mentioned above.

In order to decrease the oblique incidence angle, it is preferable that light beams cross at a point, which is located between the light source and the light deflector 44 and is closer to the light deflector, so that the reflection points of the light beams on a reflection/deflection surface are separated in the sub-scanning direction.

Since the scanning lens 46 is a common lens which is prepared by integral molding and in which lens surfaces are arranged side by side in the sub-scanning direction, the interval between light beams passing through the scanning lens 46 can be narrowed. In this regard, since the transmission points of light beams in the scanning lenses 45 and 46 vary in the sub-scanning direction due to production errors and assembly errors of the optical members used, it is necessary for each of the lens surfaces to have a certain transmission area, and therefore the interval between light beams passing through the scanning lenses 45 and 46 has a lower limit. Therefore, when the scanning lenses 45 and 46 are set so as to be close to the light deflector 44 to reduce the size of the optical scanning device, or when the flexibility in designing the layout of the optical scanning device is enhanced to reduce the size of the optical scanning device, the oblique incidence angle has to be increased.

Needless to say, the oblique incidence angle decreasing effects can be produced by the scanning lenses 45 and 46 more effectively than in a case where conventional scanning lenses are set so as to be overlaid in the sub-scanning direction. However, when the scanning lenses 45 and 46 are arranged so as to be closer to the light deflector 44 to enhance the optical property mentioned above, it is desired to further decrease the oblique incidence angle.

As illustrated in FIG. 19, light beams are not crossed in the sub-scanning direction on the reflection surface of the polygon mirror of the light deflector 44. In this example, light beams cross at a point, which is located between the light source and the reflection/deflection surface of the light deflector and is closer to the light deflector, so that the reflection points of light beams on the reflection/deflection surface of the light deflector 44 are separated by (h) from each other. As a result, it becomes possible that the oblique incidence angle is decreased (i.e., change of the oblique incidence angle from the angle illustrated by broken lines to the angle illustrated by solid lines in FIG. 19) while maintaining the light beam interval needed for separating light beams in the sub-scanning direction. In this regard, it is not preferable from the viewpoint of costs, noises and power consumption of the light deflector 44 to increase the thickness (in the sub-scanning direction) of the reflection/deflection surfaces of the polygon mirror of the light deflector 44, and therefore the thickness is preferably from 3 mm to 4 mm. In contrast, in a case where light beams are parallel to the normal line (n) of the reflection/deflection surface of the light deflector 44, and scanning lens has a structure such that lenses are overlaid in the sub-scanning direction, the thickness of the polygon mirror in the sub-scanning direction is generally from 8 mm to 10 mm. Therefore, even when the thickness of the polygon mirror in the sub-scanning direction is slightly increased in this example, increase in costs of the optical scanning device is little, and the effects to reduce noise and power consumption of the light deflector 44 can be satisfactorily produced.

In conventional oblique incidence type optical scanning devices, the oblique incidence angle is generally from 3° to 5° in order that the optical scanning device can have a proper optical layout. In this example, the oblique incidence angle is about 1°, and therefore the optical scanning device can have good optical property. This point will be described later in detail by reference to an example (Example 2).

In order to control the variation of intervals of scanning lines in the sub-scanning direction caused by variation in the length A of the polygon mirror of the light deflector 44, it is preferable to determine the angle in the sub-scanning direction of light beams incident on the light reflector 44 relative to the normal line (n) of the reflection/deflection surfaces so that the following relation is satisfied:

ΔS×β<5 μm,

wherein ΔS represents variation in position of reflection points on the plural reflection/deflection surfaces of the light deflector 44, and β represents magnification of the scanning lenses 45 and 46. When the variation is greater than that, the image quality deteriorates (for example, images with uneven image density are formed).

By properly decreasing the magnification of the scanning optics in the sub-scanning direction (as mentioned before) while properly decreasing the oblique incidence angle (as mentioned above), increase in thickness in the sub-scanning direction of the light deflector 44 can be prevented, and the scanning lenses 45 and 46 can be set so as to be close to the light deflector 44, resulting in maintenance of flexibility in designing layout of the optical scanning device. Therefore, a compact optical scanning device, which has good optical property and in which variation of intervals of scanning lines in the sub-scanning direction is reduced, can be provided.

Plural light beams emitted by the light source 41 are focused in the vicinity of the reflection/deflection surfaces of the light deflector 44 by an optical element such as the cylindrical lens 43. In this regard, it is preferable that the optical element is commonly used by the plural light beams traveling toward the same reflection/deflection surface, and is set at a cross point at which the light beams cross in the sub-scanning direction. In this regard, the optical element (such as the cylindrical lens 43) having a function to focus light beams in the sub-scanning direction in the vicinity of the reflection/deflection surface has a problem to be solved concerning the installation location thereof. Specifically, when a cylindrical lens is provided for each light source, it is necessary to increase the oblique incidence angle of light beams.

Therefore, in this example, the optical element (such as the cylindrical lens 43) is commonly used by plural light beams traveling toward the same reflection/deflection surface, and is set at a cross point at which the light beams cross in the sub-scanning direction. As a result, it becomes possible to focus the light beams in the vicinity of the reflection/deflection surface without largely change the oblique incidence angle of the light beams.

In this regard, it is also possible that two light sources 41 are set so as to be separated in the main scanning direction, and an optical element (such as the cylindrical lens 43) is provided for each light source. In this case, by changing the shapes of the surfaces of the scanning lenses 45 and 46, the optical scanning device can have good optical property.

However, in order that the optical scanning device has merits such that the number of parts is reduced, and the lens surface is commonly used, the above-mentioned example is preferable.

In addition, in order to avoid interference of the coupling lens 42 to change diverging light emitted by the light source 41 to a desired light flux state (i.e., to perform coupling), it is possible to separate the light sources 41 in the main scanning direction, and the optical element (such as the cylindrical lens 43) is commonly used by the light beams emitted by the light sources. In this regard, it is preferable that the light beams are crossed in the vicinity of the reflection/deflection surface of the light deflector 14 in the main scanning direction. If the distance between the light sources is relatively short, the surfaces (such as 46b) of the scanning lenses 45 and 46 may have the same shape.

Next, another example of the optical scanning device of the present invention will be described. The configuration of this eleventh example is substantially the same as those of the seventh to tenth examples of the optical scanning device mentioned above.

The seventh to tenth examples of the optical scanning device mentioned above irradiate two scanning surfaces using the light deflector 44. By setting two sets of the optical scanning device (such as the seventh to tenth examples), it becomes possible to irradiate four scanning surfaces and to form a full color image. Alternatively, a method in which the light deflector 44, which has relatively high costs, is commonly used, and two sets of the above-mentioned optical scanning device are set so that the light beams emitted by the two optical scanning devices are reflected and deflected by the opposed reflection/deflection surfaces of the light deflector can also be used. In this case, by allowing the oblique incidence angles of all the light beams to be the same, the same two sets of scanning lenses can be used for the two optical scanning devices. Since conventional optical scanning devices use for forming full color images used four to eight scanning lenses, the number of scanning lenses can be reduced. In addition, the resultant optical scanning device has good optical property while having small size and low costs.

Next, another example of the image forming apparatus of the present invention will be described. The image forming apparatus of the present invention uses one of the seventh to eleventh examples of the optical scanning devices mentioned above.

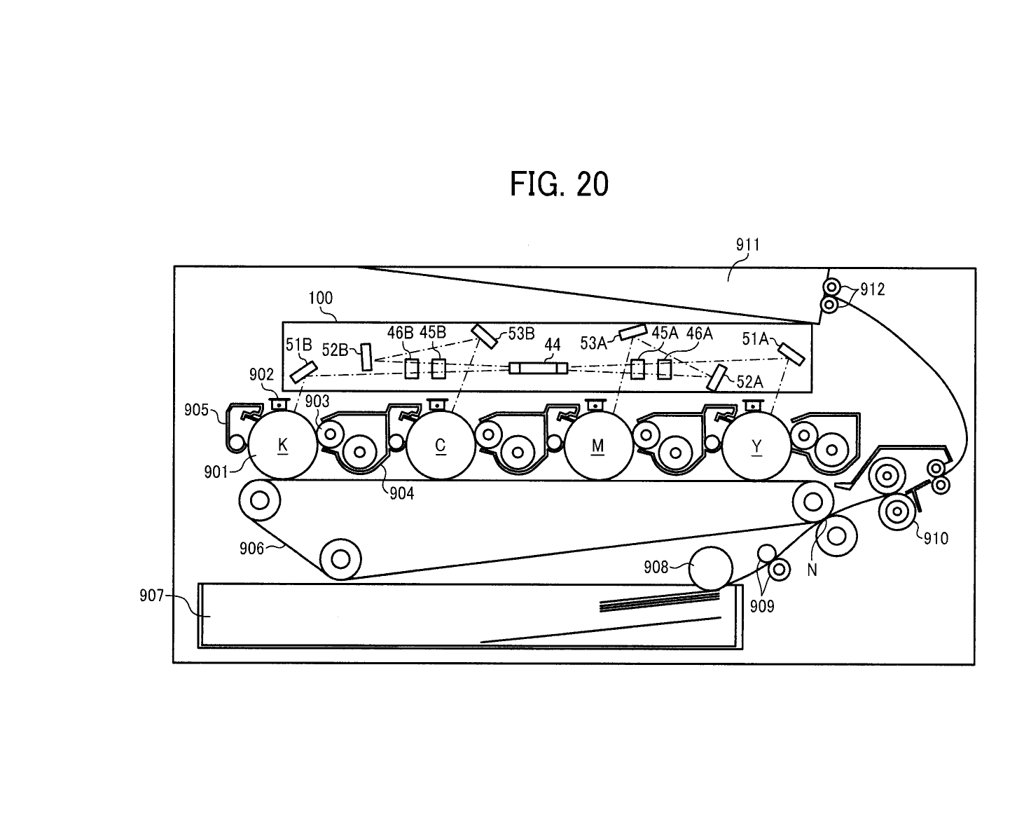

An example of the image forming apparatus of the present invention will be described by reference to FIG. 20. FIG. 20 is a schematic cross-sectional view illustrating the main portion of a tandem full color laser printer.

Hereinbefore, examples of the optical scanning device irradiating two scanning surfaces have been described. By setting two sets of the optical scanning device, four scanning surfaces can be irradiated, thereby making it possible to form a full color image. Alternatively, a method in which the light deflector 44, which has relatively high costs, is commonly used, and two sets of the above-mentioned optical scanning device are set so that the light beams emitted by the two optical scanning devices are reflected and deflected by the opposed reflection/deflection surfaces of the light deflector can also be used. In this case, by allowing the oblique incidence angles of all the light beams to be the same, the same two sets of scanning lenses can be used for the two optical scanning devices. Since conventional optical scanning devices use for forming full color images use four to eight scanning lenses, the number of scanning lenses can be reduced. In addition, the resultant optical scanning device has good optical property while having small size and low costs.

The tandem full color laser printer illustrated in FIG. 20 has substantially the same configuration as that of the tandem full color laser printer illustrated in FIG. 8 except that the feeding belt 117 is replaced with an intermediate transfer belt 906. Therefore, the configuration of the printer will be described briefly.

Referring to FIG. 20, at the bottom portion of the printer, a recording material sheet cassette 907, which is horizontally set to feed a sheet of a recording material toward a pair of registration rollers 909 using a pick-up roller 908, and the intermediate transfer belt 906 to feed color toner images while bearing the images thereon are arranged. Above the intermediate transfer belt 906, four photoreceptors 901 to form Y, M, C and K color images respectively are arranged side by side at regular intervals from the upstream side relative to the sheet feeding direction. The four photoreceptors 901 have the same diameter, and process devices to perform electrophotographic image forming processes are arranged around each of the photoreceptors. Specifically, a charger 902, an optical scanning system 100, a developing device 904, a transfer charger (not shown), a cleaner 905, etc., are arranged around the photoreceptor 901. In this printer, light beams emitted by the optical scanning system 100 are focused on the surfaces (scanning surfaces) of the respective photoreceptors 901. The optical scanning system 100 uses a counter scanning method, and uses only one light deflector (i.e., the light deflector 44), and two pairs of scanning lenses (45A, 46A) and (45B, 46B), wherein the pair of scanning lenses (45A, 46A) is used for the photoreceptors 901Y and 901M, and the pair of scanning lenses (45B, 46B) is used for the photoreceptors 901C and 901K. In addition, a fixing device 910 is arranged on a downstream side from a secondary transfer nip N, at which the color toner images are transferred from the intermediate transfer belt 906 to the recording material sheet, to fix the color toner images to the recording material sheet. The fixing device 910 is connected with a pair of discharging rollers 912 and a copy tray 911 by a sheet passage.

The optical scanning system 100 uses two sets of the optical scanning device illustrated in FIG. 14. Specifically, the scanning lenses 45A and 46A, and light reflecting mirrors 51A, 52A and 53A are arranged on a right side of the light deflector 44, and the scanning lenses 45B and 46B, and light reflecting mirrors 51B, 52B and 53B are arranged on a left side of the light deflector 44.

When this printer is in a full color mode (multi-color mode), i.e., the printer produces full (multiple) color images, the optical scanning device 100 irradiates the surfaces of the photoreceptors 901Y, 901M, 901C and 901K with light beams according to Y, M, C and K image information to form electrostatic latent images corresponding to the Y, M, C and K images on the respective photoreceptors 901Y, 901M, 901C and 901K. These electrostatic latent images are developed with respective developing rollers 903Y, 903M, 903C and 903K of the developing devices 904 using Y, M, C and K toners, resulting in formation of Y, M, C and K toner images on the surfaces of the respective photoreceptors 901Y, 901M, 901C and 901K. The color toner images are sequentially transferred onto the intermediate transfer belt 906, thereby forming a combined color toner image on the intermediate transfer belt 906. After the combined color toner image is transferred onto the recording material sheet at the secondary transfer nip N, the combined color toner image is fixed on the recording material sheet by the fixing device 910. The recording material sheet bearing the fixed full color toner image is then discharged by the pair of discharging rollers 912 so as to be stacked on the copy tray 911.

When the above-mentioned optical scanning device of the present invention is used for the optical scanning system 100, bending of scanning lines and deterioration of wave aberration can be reduced, thereby making it possible to provide an image forming apparatus which can produce high quality images having good image reproducibility without causing the misalignment problem.

The above-mentioned plural surfaces of the scanning lenses arranged in the sub-scanning direction are respectively used for light beams used for irradiating different scanning surfaces. Needless to say, the plural surfaces can be considered to be one surface represented by one formula (i.e., formula representing the profile shape of the surfaces).

### Example 2

A specific example of the above-mentioned seventh to eleventh examples of the optical scanning device will be described in detail by reference to specific numerical data.

In an optical scanning device having such a configuration as illustrated in FIGS. 13-15, light beams having a wavelength of 659 nm are emitted by the light source 41, and the light beams are converted to parallel light fluxes by the coupling lens 42 having a focal length of 27 mm. The cylindrical lens 43, which has a refracting power only in the sub-scanning direction, focuses the parallel light fluxes in the sub-scanning direction in the vicinity of a reflection/deflection surface of the light deflector 44, which has four reflection/deflection surfaces and whose inscribed circle has a radius (A) of 7 mm. In this regard, the cylindrical lens 43 is a resin lens, which has a refractive index of 1.5271 against light with a wavelength of 659 nm (in contrast, the coupling lens 42 has a refractive index of 1.6894 against light with a wavelength of 659 nm) and which has a diffractive surface having a function to correct change of the focal position, which is caused by change of temperature, only in the sub-scanning direction. The reason why the cylindrical lens 43 is provided to correct change of the focal position, which is caused by change of temperature, is that the scanning lenses 45 and 46 have a high magnification in the sub-scanning direction. By using such a coupling lens, the optical scanning device can have good optical property.

The light beams emitted by the light source 41 have an oblique incidence angle of 1° against the normal line (n) of the reflection/deflection surface of the light deflector 44. Namely, two light beams used for forming electrostatic latent images on different scanning surfaces are obliquely incident on the reflection/deflection surface at angles of +1° and −1°. In this regard, the light beams are incident on the reflection/deflection surface at an angle of 68° in the main scanning direction relative to the normal line (n) of the reflection/deflection surface.

In this example, two coupling lenses are used for two light beams, and one cylindrical lens is commonly used for the two light beams.

In this example, the distance between the rotation axis of the light deflector 44 and the light entering surface of the first scanning lens 45 is 36 mm, the thickness of the center of the first scanning lens 45 is 7 mm, the thickness of the center of the second scanning lens 46 is 5 mm, and the distance between the rotation axis of the light deflector 44 and the scanning surfaces is 210 mm. Optical elements 47 and 48, which do not have a refracting power in both the main and sub scanning directions and which have a thickness of 1.9 mm, are arranged at locations apart from the scanning surfaces toward the light deflector by 45 mm. Each of the scanning lenses 45 and 46 has a refractive index of 1.5271 against light with a wavelength of 659 nm.

In this example, two light beams irradiate different scanning surfaces (i.e., photoreceptors 49 and 50). Therefore, a combination of the scanning lenses 45 and 46 is commonly used by the two light beams. The light entering surfaces of the scanning lenses 45 and 46, and the light exiting surface of the scanning lens 45 are a flat surface having no curvature in the sub-scanning direction, and the light exiting surface 46b of the second scanning lens 46 is constituted of two surfaces 46b-1 and 46b-2, which are arranged side by side in the sub-scanning direction and each of which has a positive refracting powering the sub-scanning direction. The surfaces 46b-1 and 46b-2 have the same shape. The surfaces 46b-1 and 46b-2 will be described later in detail.

Light beams to irradiate different scanning surfaces are incident on a reflection/deflection surface of the light deflector 44 in such a manner that the light beams have oblique incidence angles of +1° and −1° and are symmetry relative to a symmetry plane, which is mentioned later. The distance in the sub-scanning direction between two reflection points of the light beams on the reflection/deflection surface is about 2.5 mm, and the thickness of the light deflector 44 in the sub-scanning direction is 4 mm.

By separating the two reflection points in the sub-scanning direction, it becomes possible to separately guide the light beams to the respective scanning surfaces using light reflecting mirrors even when the oblique incidence angle is low.

The plural lens surfaces 46b-1 and 46b-2 are arranged so as to be symmetric in the sub-scanning direction about a symmetry plane, which extends in the main scanning direction while including a midpoint of the reflection points of two light beams on the reflection/deflection surface of the light deflector 44, and the normal line (n) of the reflection/deflection surface. In addition, the clusters of vertices of profile lines V1 and V2 (i.e., generatrices P1 and P2 (or reference axes)) of each of the lens surfaces 46b-1 and 46b-2 are shifted toward the symmetry plane (i.e., the center of the scanning lens 46 in the sub-scanning direction), so that the distance between the generatrices P1 and P2 and the symmetry plane is 1.5 mm. In this regard, the distance between the intersections of light beams with the lens surfaces 46b-1 and 46b-2 and the generatrices P1 and P2 is about 0.5 mm at the center of the scanning lens in the main scanning direction, namely the distance between the intersections and the symmetry plane is about 2.0 mm (1.5+0.5) at the center of the scanning lens.

The shapes of the light entering surface and the light exiting surface of each of the scanning lenses 45 and 46 used for this example are described in Table 2 below. In this regard, the profile of the surfaces of the scanning lenses is indicated by the below-mentioned formula (1). In this regard, the curvature of each of the light exiting surfaces 46b-1 and 46b-2 of the scanning lens 46 in the sub-scanning direction changes in the main scanning direction.

$$X ( Y , Z ) = \frac{{Y}^{2} \cdot Cm}{1 + \sqrt{1 - ( 1 + K ) \cdot {( Y \cdot Cm )}^{2}}} + A \cdot {Y}^{4} + B \cdot {Y}^{6} + C \cdot {Y}^{8} + D \cdot {Y}^{10} + E \cdot {Y}^{12} … + \frac{Cs ( Y ) \cdot {Z}^{2}}{1 + \sqrt{1 - {\{ Cs ( Y ) \cdot Z \}}^{2}}} \\ Cm = 1 / RY \\ Cs ( Y ) = ( 1 / RZ ) + aY + {bY}^{2} + {cY}^{3} + {dY}^{4} + {eY}^{5} + {fY}^{6} + {gY}^{7} + {hY}^{8} + {iY}^{9} + {jY}^{10} … \qquad ( 1 )$$

In formula (1), RY represents the paraxial curvature radius of a main scanning cross-section, which is a cross-section parallel to the main scanning direction, Y represents the distance in the main scanning direction from the reference axis, Z represents the distance in the sub-scanning direction from the reference axis, A, B, C, D . . . represent high order coefficients, and RZ represents the paraxial curvature radius of a sub-scanning cross-section, which is a cross-section perpendicular to the main scanning cross-section.

Thus, the shape profile of a lens surface is indicated by a depth data (X(Y,Z)) in a direction perpendicular to the main and sub-scanning directions.

TABLE 2
Surfaces of scanning lenses 45 and 46

| | Light entering | Light exiting | Light entering | Light exiting |
|---|---|---|---|---|
| | surface 45a | surface 45b | surface 46a | surface 46b |
| RY | 251.457 | −142.607 | −3536.664 | −1334.842 |
| K | — | — | — | — |
| A | −4.610259 × 10⁻⁶ | −2.803729 × 10⁻⁷ | −2.338761 × 10⁻⁷ | −2.333940 × 10⁻⁶ |
| B | 9.725969 × 10⁻⁹ | 4.480345 × 10⁻⁹ | −1.798551 × 10⁻⁹ | −2.927556 × 10⁻¹⁰ |
| C | −2.174221 × 10⁻¹¹ | −1.485974 × 10⁻¹¹ | −5.332653 × 10⁻¹⁴ | 1.466323 × 10⁻¹³ |
| D | 2.203216 × 10⁻¹⁴ | 1.272381 × 10⁻¹⁴ | 7.290674 × 10⁻¹⁶ | 5.363869 × 10⁻¹⁷ |
| E | −1.092525 × 10⁻¹⁷ | −2.870521 × 10⁻¹⁸ | 8.116538 × 10⁻²⁰ | −2.870874 × 10⁻²⁰ |
| F | 3.210707 × 10⁻²¹ | −2.314897 × 10⁻²² | −1.719263 × 10⁻²² | 5.786869 × 10⁻²⁴ |
| R_{z} | ∞ | ∞ | ∞ | −18.492 |
| a | — | — | — | −2.646740 × 10⁻⁶ |
| b | — | — | — | 1.631368 × 10⁻⁵ |
| c | — | — | — | −5.322549 × 10⁻⁹ |
| d | — | — | — | −1.394239 × 10⁻⁸ |
| e | — | — | — | −2.118625 × 10⁻¹² |
| f | — | — | — | 2.039745 × 10⁻¹² |
| g | — | — | — | 4.159937 × 10⁻¹⁵ |
| h | — | — | — | 9.973235 × 10⁻¹⁶ |

In Table 2, Rm represents the curvature (in units of mm) in the main scanning direction, and Rs represents the curvature (in units of mm) in the sub-scanning direction, wherein Rm=1/Cm, and Rs=1/Cs.

In addition, the reference axis of each lens surface is defined as the normal line at the origin of formula (2), and is parallel to the symmetry plane mentioned above.

As mentioned above, since the lens surface 46b has asymmetric shape in the main scanning direction (since the coefficients of B include an odd order coefficient, it can be understood that the curvature in the sub-scanning direction changes asymmetrically in the main scanning direction), bending of image surface and deviation of magnification in the sub-scanning direction can be effectively reduced. In this regard, as mentioned above, reduction of deviation of magnification reduces bending of scanning lines. By commonly using a scanning lens, in which two layers are integrated, for plural light beams, the resultant optical scanning device have simpler structure, lower costs, and better optical property than an optical scanning device using a combination of plural kinds of scanning lenses.

The optical elements 47 and 48, which are arranged between the scanning lenses 45 and 46 and the scanning surfaces (photoreceptors 49 and 50) and which have no refracting power in the main scanning and sub-scanning directions, are set so as to be tilted at an angle of 14° in the sub-scanning direction relative to the reference axis of the scanning lenses 45 and 46 when the light beams are reflected by the light reflecting mirrors 51-53. In this regard, the optical elements 47 and 48 are tilted in opposite directions (similarly to the case illustrated in FIG. 9) because the light beams passing the upper portion and lower portion of the scanning lenses are similarly influenced optically.

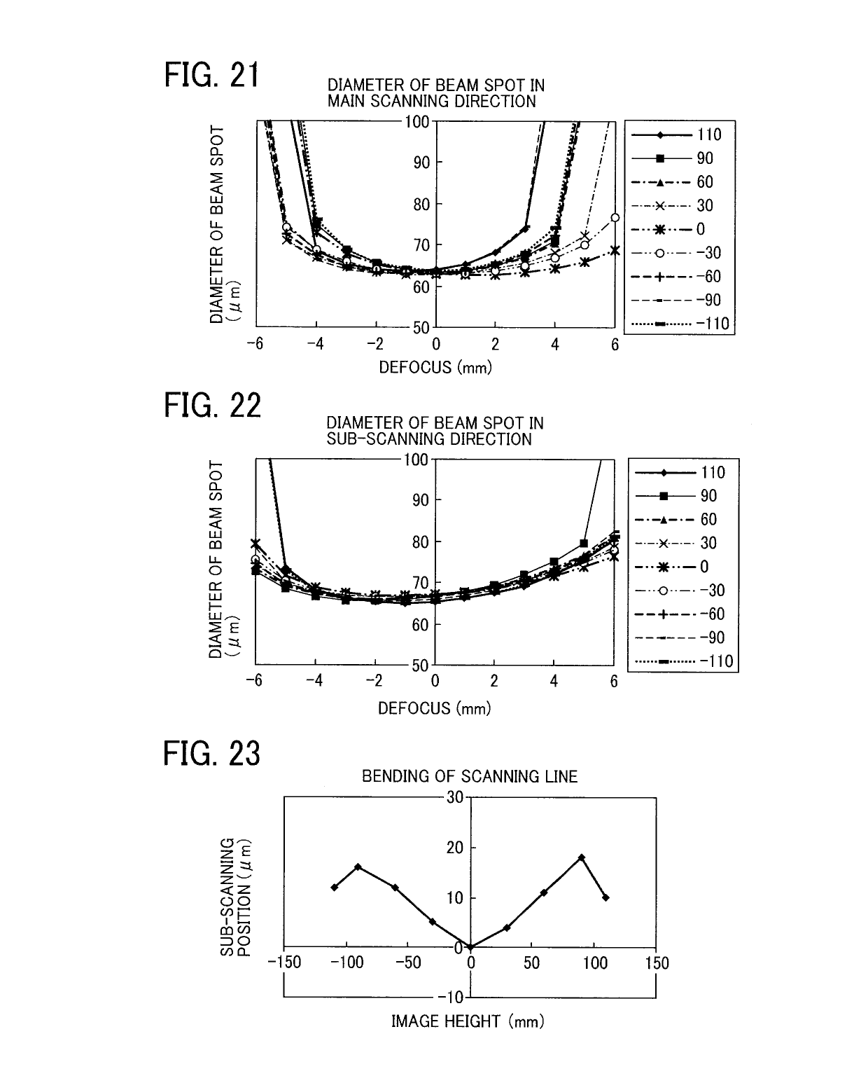

It is clear from FIGS. 21 and 22 that light beam spots formed by the optical scanning device of Example 2 have little deviation even when the image height changes. Specifically, FIG. 21 illustrates the diameters of beam spots in the main scanning direction when the image height is changed at nine levels (±110, ±90, ±60, ±30, 0), and FIG. 22 illustrates the diameters of beam spots in the sub-scanning direction when the image height is changed at the nine levels. Namely, the wave aberration is satisfactorily corrected. In this example, a rectangular aperture having a length of 2.5 mm in the main scanning direction and a length of 2.2 mm in the sub-scanning direction is arranged between the coupling lens 42 and the cylindrical lens 43 having a refracting power only in the sub-scanning direction to form a beam spot.

In addition, as illustrated in FIG. 23, bending of a scanning line is as small as about 19 μm. The bending of a scanning line is defined as the PV value (Peak-Valley value) in the sub-scanning direction of a scanning line formed on a scanning surface.

By setting the optical scanning device of this example on both sides of a polygon scanner, which serves as the light deflector 44 and which is commonly used by the optical scanning devices, it becomes possible to scan four different scanning surfaces. Namely, such an optical scanning device can be preferably used as the optical scanning device of a full color image forming apparatus, which can produce full color images (Y, M, C and K images).

Additional modifications and variations of the present invention are possible in light of the above teachings. It is therefore to be understood that within the scope of the appended claims the invention may be practiced other than as specifically described herein.

What is claimed is:

1. An optical scanning device comprising:
multiple light sources to emit multiple light beams for scanning multiple different scanning surfaces;
a light deflector having multiple reflection and deflection surfaces and rotating on a rotation axis in a main scanning direction to reflect and deflect the multiple light beams such that at least two light beams of the multiple light beams are reflected and deflected by same one of the multiple reflection and deflection surfaces at different angles in a sub-scanning direction relative to a normal line of the same one of the multiple reflection and deflection surfaces; and
at least one scanning lens to focus the at least two light beams reflected and deflected by the same one of the multiple reflection and deflection surfaces on at least two of the multiple different scanning surfaces, respectively, wherein at least one of surfaces of the at least one scanning lens has a surface having multiple refracting surfaces arranged side by side in the sub-scanning direction, and wherein each of the multiple refracting surfaces has a positive refracting power in the sub-scanning direction, and vertices of the refracting surfaces are shifted in the sub-scanning direction from intersections of the at least two light beams with the multiple refracting surfaces toward a center of the at least one scanning lens.

2. The optical scanning device according to claim 1, wherein chief rays of the at least two light beams exiting from the multiple refracting surfaces are substantially parallel to a plane perpendicular to the rotation axis of the light deflector, and wherein the chief rays exiting from centers of the multiple refracting surfaces have a greater exit angle in the sub-scanning direction than the chief rays exiting from an end portion of the refracting surfaces in the main scanning direction.

3. The optical scanning device according to claim 1, wherein multiple generatrices of the multiple refracting surfaces of the at least one scanning lens, each of which is defined as a cluster of vertices of profile lines of the multiple refracting surfaces extending in the sub-scanning direction, are located on planes parallel to a normal line of the multiple reflection and deflection surfaces of the light deflector.

4. The optical scanning device according to claim 1, wherein a surface of the at least one scanning lens opposite to the surface having the multiple refracting surfaces is flat in the sub-scanning direction.

5. The optical scanning device according to claim 4, wherein the flat surface of the at least one scanning lens is parallel to the ration axis of the light deflector.

6. The optical scanning device according to claim 1, wherein the surface of the at least one scanning lens having the multiple refracting surfaces is closer to the multiple different scanning surfaces than a surface of the at least one scanning lens opposite to the surface having the multiple refracting surfaces.

7. The optical scanning device according to claim 1, wherein the at least two light beams to be reflected and deflected by the same one of the multiple reflection and deflection surfaces are crossed in the sub-scanning direction at a location between the multiple light sources and the multiple reflection and deflection surfaces so that reflection points of the at least two light beams on the same one of the multiple reflection and deflection surfaces are apart from each other in the sub-scanning direction.

8. The optical scanning device according to claim 7, further comprising:
an optical element to focus the multiple light beams in the vicinity of the multiple reflection and deflection surfaces of the light deflector, wherein the optical element is commonly used for the at least two light beams to be reflected and deflected by the same one of the multiple reflection and deflection surfaces, and is located at a location in which the at least two light beams are crossed in the sub-scanning direction.

9. The optical scanning device according to claim 1, including:
at least two sets of the at least one scanning lens,
wherein the light deflector reflects the at least two light beams at one of the multiple reflection and deflection surfaces so that the at least two light beams pass through one of the at least two sets of the at least one scanning lens while reflecting at least two other light beams of the multiple light beams emitted by the multiple light sources at another of the multiple reflection and deflection surfaces so that the at least two other light beams pass through another of the at least two sets of the at least one scanning lens, to irradiate at least four different scanning surfaces.

10. The optical scanning device according to claim 1, wherein the at least one scanning lens is a single solid lens.

11. The optical scanning device according to claim 1, wherein the at least one scanning lens consists essentially of two lenses, and wherein the two lenses are commonly used for the at least two light beams reflected and deflected by the same one of the multiple reflection and deflection surfaces of the light deflector.

12. An image forming apparatus comprising:
at least two image bearing members;
the optical scanning according to claim 1 to scan scanning surfaces of the at least two image bearing members to form electrostatic latent images on the scanning surfaces of the image bearing members.
